(19) United States
(12) Patent Application Publication
(10) Pub. No.: US 2022/0301085 A1
(43) Pub. Date: Sep. 22, 2022

(54) SERVICE PROVIDING SYSTEM, INFORMATION PROCESSING METHOD, AND RECORDING MEDIUM

(71) Applicant: Takuya SONEDA, Kanagawa (JP)

(72) Inventor: Takuya SONEDA, Kanagawa (JP)

(73) Assignee: Ricoh Company, Ltd., Tokyo (JP)

(21) Appl. No.: 17/652,748

(22) Filed: Feb. 28, 2022

(30) Foreign Application Priority Data
Mar. 18, 2021 (JP) 2021-045234

(51) Int. Cl. G06Q 50/18; G06F 21/10

(52) U.S. Cl. CPC G06Q 50/18; G06F 21/105; G06Q 2220/18

(57) ABSTRACT

A service providing system includes circuitry; and a memory storing computer-executable instructions that cause the circuitry to execute generating screen information of a screen configured to accept, from a user, an assignment operation of assigning a use right to use a service; transmitting the screen information to a terminal apparatus; assigning the use right to the user or a device belonging to a group in a tenant, within a limit of a number of licenses; and managing the assignment of the use right when a first group and a second group included in the tenant are merged, such that the use right that has been available for assignment in the first group before the merger and that is not yet assigned, is preferentially assigned to the user or the device belonging to the first group.

### CROSS-REFERENCE TO RELATED APPLICATION

The present application is based on and claims priority under 35 U.S.C. § 119 to Japanese Patent Application No. 2021-045234, filed on Mar. 18, 2021, the contents of which are incorporated herein by reference in their entirety.

### BACKGROUND OF THE INVENTION

### 1. Field of the Invention

The present invention relates to a service providing system, an information processing method, and a recording medium.

### 2. Description of the Related Art

When a company uses a service according to software or a device, etc., by dividing the scope of providing the service into organizational information units referred to as tenants, and making contracts according to the division, the service can be used flexibly according to the needs and budgets of the organizations. Here, in the case of merging tenants, in order to reduce the load required for changing the settings after the tenants are merged, there is disclosed a configuration of setting the security level in the tenants after the merger (see Patent Document 1).
Patent Document 1: Japanese Unexamined Patent Application Publication No. 2020-38548

### SUMMARY OF THE INVENTION

According to one aspect of the present invention, there is provided a service providing system configured to manage assignment of a use right to use a service, to a user or a device belonging to a group in a tenant, the service providing system including circuitry; and a memory storing computer-executable instructions that cause the circuitry to execute generating screen information of a screen configured to accept, from the user, an assignment operation of assigning the use right of the service; transmitting the screen information to a terminal apparatus; assigning the use right to the user or the device belonging to the group within a limit of a number of licenses; and managing the assignment of the use right when a first group and a second group included in the tenant are merged, such that the use right that has been available for assignment in the first group before the merger and that is not yet assigned, is preferentially assigned to the user or the device belonging to the first group.

### BRIEF DESCRIPTION OF THE DRAWINGS

FIG. 1 is a diagram illustrating an example of a data model of a tenant according to a first embodiment of the present invention;

FIG. 2 is a diagram illustrating an example of a configuration of a service providing system according to the first embodiment of the present invention;

FIG. 3 is a diagram illustrating an example of a detailed configuration of an information processing system according to the first embodiment of the present invention;

FIG. 4 is a diagram illustrating an example of a hardware configuration of a terminal apparatus or an information processing system according to the first embodiment of the present invention;

FIG. 5 is a diagram illustrating an example of a functional configuration of a service providing system according to the first embodiment of the present invention;

FIG. 6 is a diagram illustrating an example of a functional configuration of a group managing unit according to the first embodiment of the present invention;

FIG. 7 is a conceptual diagram illustrating a relationship between the user and the application use right of each group according to the first embodiment of the present invention;

FIG. 8 is a conceptual diagram illustrating a problem in the relationship between the user and the application use right of each group according to the first embodiment of the present invention;

FIG. 9 is a conceptual diagram illustrating a solution in the relationship between the user and the application use right of each group according to the first embodiment of the present invention;

FIG. 10 is a diagram illustrating an example of a group management screen according to the first embodiment of the present invention;

FIG. 11 is a diagram illustrating an example of a group management screen at the time of group merger according to the first embodiment of the present invention;

FIG. 12 is a sequence diagram illustrating an example of a group merging process according to the first embodiment of the present invention;

FIG. 13 is a diagram illustrating an example of a group management screen of application use right assignment according to the first embodiment of the present invention;

FIG. 14 is a diagram illustrating an example of a group management screen of application use right assignment according to the first embodiment of the present invention;

FIG. 15 is a diagram illustrating an example of a group management screen of the preferential assignment setting deletion of application use rights according to the first embodiment of the present invention;

FIG. 16 is a sequence diagram illustrating an example of a preferential assignment process of application use rights according to the first embodiment of the present invention;

FIG. 17 is a flowchart illustrating an example of a preferential assignment process of application use rights according to the first embodiment of the present invention;

FIG. 18 is a conceptual diagram illustrating a relationship between the user and the application use right of each group according to a second embodiment of the present invention;

FIG. 19 is a sequence diagram illustrating an example of a registration process of a merged group according to the second embodiment of the present invention;

FIG. 20 is a diagram illustrating an example of a group management screen of the application use right assignment of group C according to the second embodiment of the present invention;

FIG. 21 is a diagram illustrating an example of a group management screen of the application use right assignment of group A according to the second embodiment of the present invention;

FIG. 22 is a sequence diagram illustrating an example of a group merging process according to the second embodiment of the present invention;

FIG. 23 is a conceptual diagram illustrating a relationship between the users and the application use rights of each group according to a third embodiment of the present invention;

FIG. 24 is a sequence diagram illustrating an example of a group merging process according to the third embodiment of the present invention; and

FIG. 25 is a diagram illustrating an example of a group management screen of the application use right assignment of group C according to the third embodiment of the present invention.

### DESCRIPTION OF THE EMBODIMENTS

In tenant-based operations, a group can be created within the tenant and the scope of use of a license (contract) can be limited within the group. Then, the use right for using the service can be assigned to users or devices in units of groups.

However, when groups within a tenant are merged, there is a problem that the number of use rights for using the service to be assigned to users or devices may be insufficient, so the users or devices that were able to use the service before the merger will be unable to use the service after the merger.

A problem to be addressed by an embodiment of the present invention is to enable users or devices, that have been able to use a service prior to the merger of groups, to use the service even after the merger.

Hereinafter, an information processing apparatus, an information processing method, and a program according to an embodiment of the present invention will be described in detail with reference to the accompanying drawings.

### First Embodiment

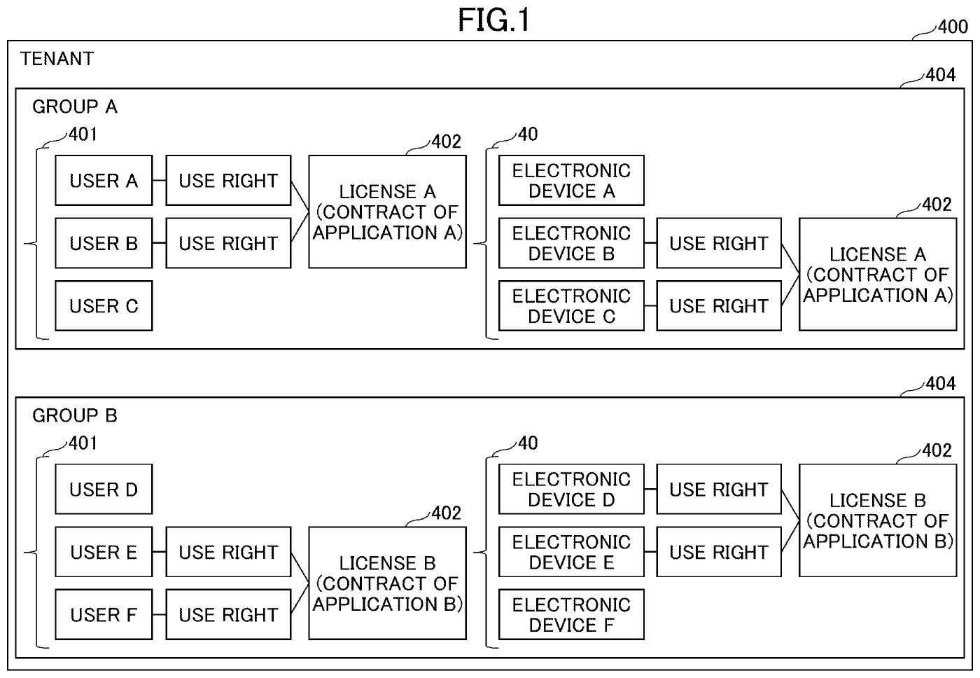

Referring first to FIG. 1, the relationship between a tenant, a user, an electronic device, and a license will be described. FIG. 1 illustrates an example of a data model of a tenant. For example, in the case of a service providing system used by companies in their business operations, information is often managed in units of companies (organization) from the viewpoint of improving security and management costs. The information processing system described below is capable of registering users, electronic devices, and licenses in a group 404 within the tenant. As illustrated in FIG. 1, there is a tenant 400 corresponding to each company, to which a user 401, an electronic device 40, and a license 402 belong. The license 402 is a contract to use an application. Applications include web applications and device-specific applications. Hereinafter, when distinguishing the user 401, a group 404, the electronic device 40, and the license 402, an upper case letter will be given, such as a user A or the like.

The users A and B belonging to group A are assigned a use right based on a license A (contract for application A), and electronic devices B and C are also assigned a use right based on a license A. Similarly, users E and F and electronic devices D and E belonging to a group B are assigned a use right based on a license B. The license 402 assigned to the user 401 may be referred to as a user license, and the license 402 assigned to the electronic device 40 may be referred to as a device license.

The tenant administrator assigns a use right to use an application to the user 401 or the electronic device 40 within the limit of the number of persons or the number of devices permitted by the license 402. When using an application, the user 401 or the electronic device 40 is typically authenticated by an authentication system. The authentication system compares the user information or device information stored in a database or the like with the information included in an authentication request, in order to determine whether authentication is successful or not.

### Terminology

A tenant means information indicating multiple customers who share the same software, i.e., a company that is an assembly of customers or the like. An application contracted by a tenant can be used by each user or device in the tenant, and the tenant administrator can grant a user or a device the use right to use multiple software instances (i.e., applications or a package of multiple applications) in the system. A tenant is a managing unit in which at least one of users or devices are grouped, and a tenant may be an assembly of users or devices belonging to the same organization or an assembly of users or devices residing in a certain region.

An application is a program executed by a terminal apparatus and an information processing apparatus, for a user to receive a service. That is, a service is a variety of functions provided by the application from an information processing system 50 to the electronic devices and terminal apparatuses. A program executed in cooperation by a terminal apparatus and an information processing apparatus, is referred to as a web application. There are also applications that are used to perform printing and scanning in an electronic device such as an image forming apparatus. An application may be, for example, a workflow application that sequentially executes a series of processes. The application can be configured by combining components by a tenant administrator and the like. For example, a combination of a document reading component, a cloud transmission component, and the like can be used to configure an application that uploads and stores a document read by an electronic device to a storage on a cloud. Applications may be licensed as the above-described package. In this case, the application package and the application are treated in the same manner. Applications also include applications that are installed and used in electronic devices. Functions of an application can be executed by a single electronic device, such as an image forming apparatus. However, at a predetermined timing, such as when the application is activated, when the application function is executed, or when the electronic device is activated, the validity of the license may be inquired to the information processing apparatus that manages the license, and only when the license is determined to be valid in the information processing apparatus, the functions of the application may be executed.

A role is a role within the tenant. The role is entitled to a right according to the role. For example, there is a tenant administrator who has the management right for the tenant to which he or she belongs and for all groups belonging to the tenant, a group administrator who has the management right within the group to which he or she belongs, and general users who do not have any management rights. However, other roles may be created, and a management right within a tenant and a group may be set for each role. For example, the tenant administrator determines a role by considering the user's job type, the user's job title, how to use an application, and the like. Further, it may be possible to set a role of a user that can assign a use right for using an application or using a function of the application, as a role for each application. The role of the user and the role of the application do not always match, and when the role of the user has a larger right than the role of the application, the user can assign the use right to use the application. For example, when a group administrator is set as a role of an application, the group administrator or a tenant administrator with a larger right can assign the use right to use the application, but a general user cannot assign the use right to use the application.

A device means an electronic device, and an electronic device may be referred to as a device in the present embodiment.

A group is a group or an assemblage. In the present embodiment, one or more users or electronic devices randomly allocated are elements of the group. For example, a tenant administrator can allocate each user or device belonging to a tenant that is the management target, to any group. The user or device can belong to more than one group or can belong to only one group.

Limitation of the assignment of a use right means that the use right can be assigned only to a group, a user, or a device within a certain scope, or can be preferentially assigned to those in the certain scope. Limitation may be referred to as prohibition. Limitation may include a case of releasing the prohibition state by some operation.

### <System Configuration>

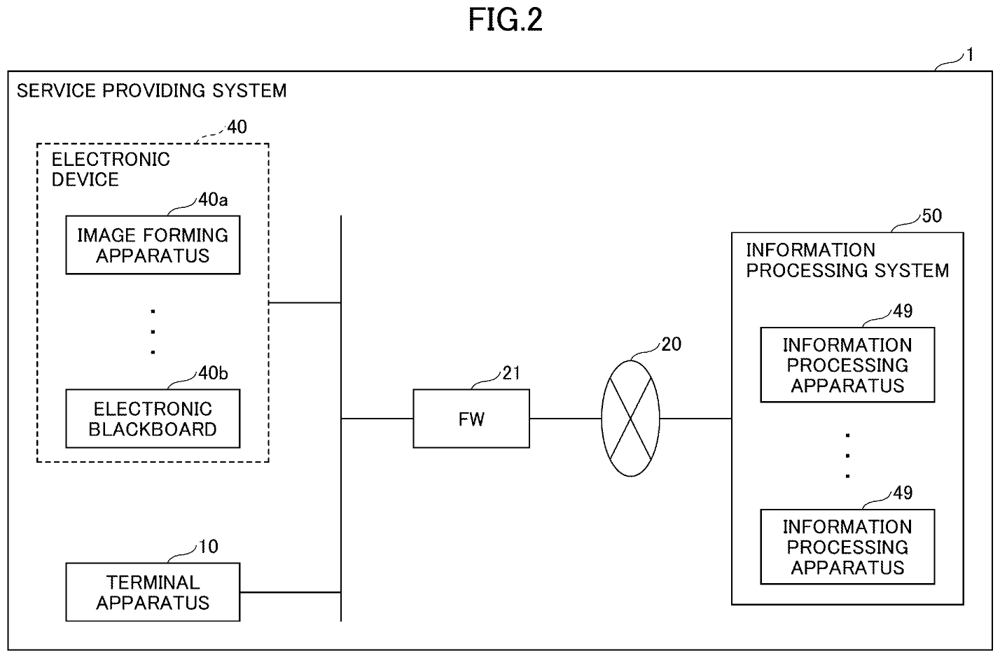

A configuration diagram of an example of a service providing system 1 according to the present embodiment will be described with reference to FIG. 2. In the service providing system 1 of FIG. 2, a terminal apparatus 10 and the electronic device 40 located in a tenant are connected to an information processing system 50 via a network 20 such as the Internet and a firewall (FW) 21.

The terminal apparatus 10 is an information processing apparatus such as a smartphone, a mobile phone, a tablet personal computer (PC), a desktop PC, a notebook PC, or the like used by the tenant administrator and a user. A program having a screen display function such as a web browser is installed in the terminal apparatus 10. The program may have a function of displaying screen information received from the information processing system 50 as a screen. The program is not limited to a web browser, but may be a program exclusively used for the information processing system 50.

The electronic device 40 is, for example, an image forming apparatus 40a, and the image forming apparatus 40a may include a laser printer, an MFP (Multifunction Peripheral/Product/Printer), or the like. The electronic device 40 may also be an electronic blackboard 40b. The electronic device 40 may also be, for example, an output device such as a projector, a digital signage, and the like, a Head Up Display (HUD) device, an industrial machine, an imaging device, a sound collector, a medical device, a network home appliance, an automobile (connected car), a notebook PC, a mobile phone, a smartphone, a tablet terminal, a game machine, a Personal Digital Assistant (PDA), a digital camera, a wearable PC, a desktop PC, or the like.

The information processing system 50 includes one or more information processing apparatuses 49 connected to the network 20. The information processing system 50 creates screen information of a web page to be displayed on the terminal apparatus 10 or the electronic device 40 and transmits the screen information. The screen information is prepared by Hyper Text Markup Language (HTML), eXtensible Markup Language (XML), cascade style sheets (CSS), JavaScript (trademark), and the like. Web pages may be provided by web applications. A web application refers to software or a software mechanism for being executed on a web browser, by coordinating a program in a programming language (e.g., JavaScript (registered trademark)) operating on a web browser with a program operating on a web server. A web application can also change a web page dynamically.

The information processing system 50 may be implemented by a single information processing apparatus 49 or may be distributed among a plurality of the information processing apparatuses 49. For example, there may be the information processing apparatus 49 for each service that provides the corresponding service, or there may be a single information processing apparatus 49 that provides a plurality of services, or there may be a plurality of the information processing apparatuses 49 that provide one service.

The information processing system 50 may be compatible with cloud computing. Cloud computing is a form of use in which resources on a network are used without considering particular hardware resources. The information processing system 50 that is compatible with cloud computing may be referred to as a cloud system. A cloud system may be on the Internet or may be on-premise.

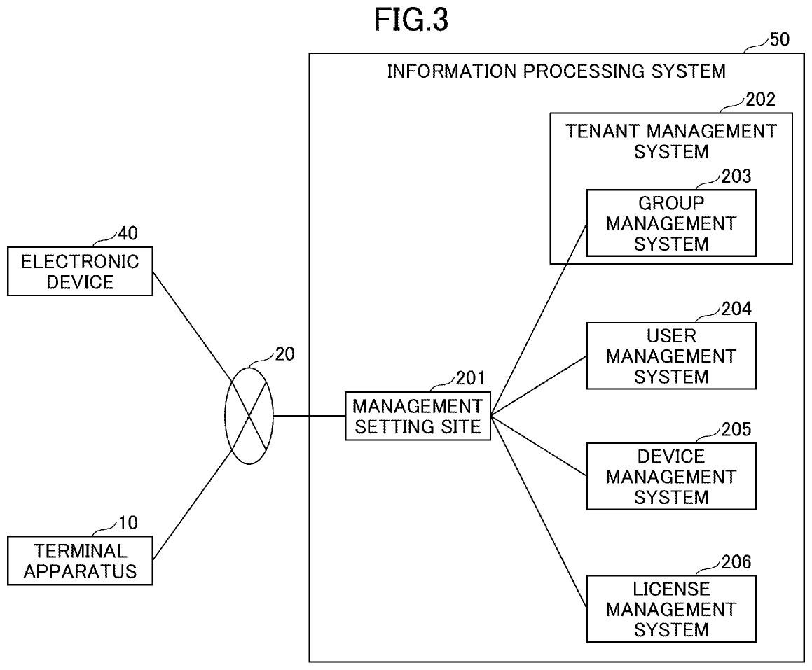

FIG. 3 is an example of a detailed configuration diagram of the information processing system 50. The information processing system 50 includes a management setting site 201, a tenant management system 202, a user management system 204, a device management system 205, and a license management system 206.

The management setting site 201 is a web server that provides a web site that accepts settings relating to the user 401, the electronic device 40, the license 402, and the group 404. The tenant administrator connects the terminal apparatus 10 to the management setting site 201 and makes various settings.

The tenant management system 202 is one or more information processing apparatuses that manage tenants, and includes a group management system 203. The group management system 203 is one or more information processing apparatuses 49 that provide the group management functions described below. The tenant management system 202 and the group management system 203 may be installed in separate information processing apparatuses 49.

The user management system 204 is one or more information processing apparatuses 49 that manage a user in a tenant. The device management system 205 is one or more information processing apparatuses 49 that manage the electronic device 40 in a tenant. The license management system 206 is one or more information processing apparatuses 49 that manage the license contracted by the tenant and a use right associated with the license.

The management setting site 201, the tenant management system 202, the user management system 204, the device management system 205, and the license management system 206 are not limited to a configuration of being implemented by separate information processing apparatuses 49, but may be implemented by a smaller number of information processing apparatuses 49.

### <Hardware Configuration>

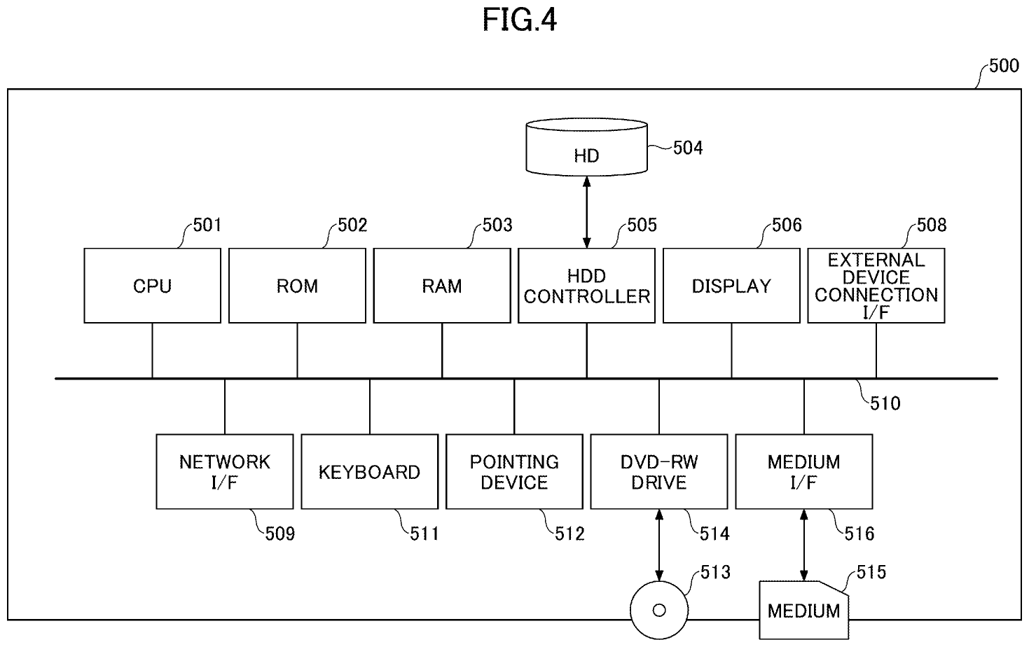

The terminal apparatus 10 or the information processing system 50 is implemented, for example, by a computer having the hardware configuration illustrated in FIG. 4. A computer 500 is constructed by a computer and includes a central processing unit (CPU) 501, a read-only memory (ROM) 502, a random access memory (RAN) 503, a hard disk (HD) 504, a hard disk drive (HDD) controller 505, a display 506, an external device connection interface (I/F) 508, a network I/F 509, a bus line 510, a keyboard 511, a pointing device 512, a Digital Versatile Disk Rewritable (DVD-RW) drive 514, and a medium I/F 516.

Among these, the CPU 501 controls the operation of the entire computer. The ROM 502 stores a program used to drive the CPU 501, such as an Initial Program Loader (IPL). The RAM 503 is used as the work area of CPU 501. The HD 504 stores various kinds of data such as a program. The HDD controller 505 controls the reading or writing of various kinds of data from or to the HD 504 according to the control of the CPU 501. The display 506 displays various kinds of information such as cursors, menus, windows, characters, images, or the like. The external device connection I/F 508 is an interface for connecting various external devices. In this case, the external device may be, for example, a Universal Serial Bus (USB) memory, a printer, or the like. The network I/F 509 is an interface for performing data communication by using the network 20. The bus line 510 is an address bus, a data bus, or the like for electrically connecting elements such as the CPU 501.

The keyboard 511 is a type of input means including a plurality of keys for input of characters, numbers, various instructions, and the like. The pointing device 512 is a type of input means for selecting and executing various instructions, selecting a processing target, moving a cursor, and the like. The DVD-RW drive 514 controls the reading or writing of various kinds of data from or to the DVD-RW 513 as an example of a removable recording medium. The recording medium is not limited to DVD-RW, but may be a Digital Versatile Disc Recordable (DVD-R), etc. The medium I/F 516 controls the reading or writing (storage) of data from or to a recording medium 515, such as a flash memory.

### <Functional Configuration>

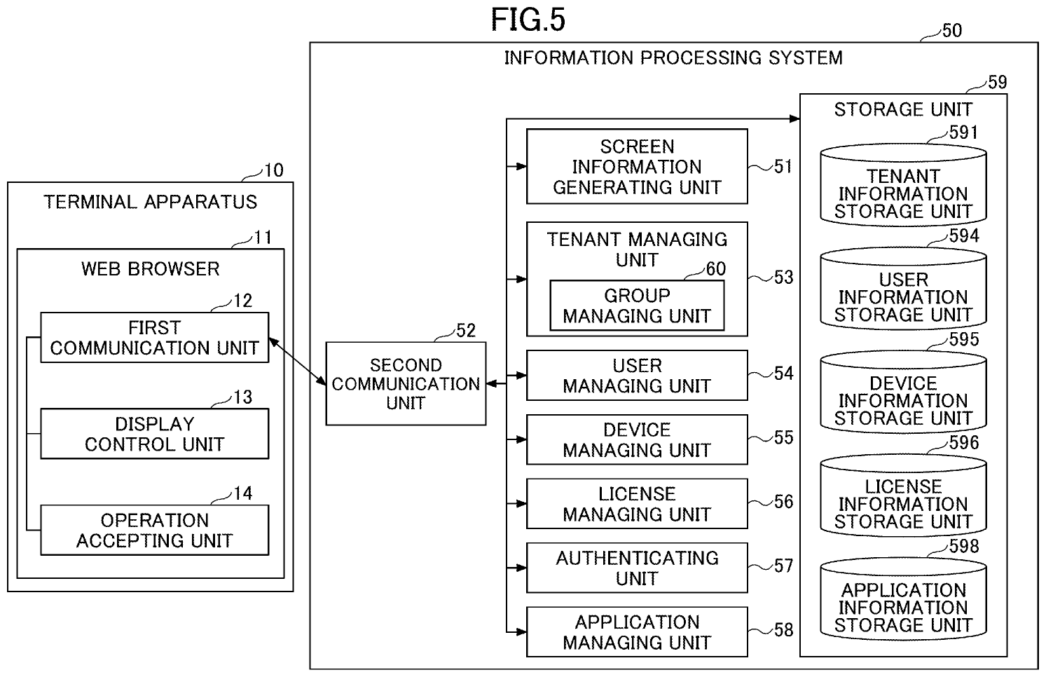

With reference to FIG. 5, functional blocks in which devices in the service providing system 1 according to the present embodiment performs processing will be described.

The terminal apparatus 10 includes a first communication unit 12, a display control unit 13, and an operation accepting unit 14. For example, the terminal apparatus 10 executes a program by a web browser 11 to implement the functional blocks as illustrated in FIG. 5. The first communication unit 12 communicates with the information processing system 50 and receives screen information for displaying a home screen or the like by the terminal apparatus 10. The tenant administrator transmits the information input to the screen, to the information processing system 50. The display control unit 13 analyzes screen information received from the information processing system 50 and displays a home screen or the like on the display 506. The operation accepting unit 14 receives an operation (input to each screen) of the tenant administrator with respect to the terminal apparatus 10.

The information processing system 50 includes a screen information generating unit 51, a second communication unit 52, a tenant managing unit 53, a user managing unit 54, a device managing unit 55, a license managing unit 56, an authenticating unit 57, and an application managing unit 58. These functions provided by the information processing system 50 are functions or means that are implemented by the CPU 501 of the computer 500 illustrated in FIG. 4 by executing a program loaded from the HD 504 to the RAM 503. The tenant managing unit 53, the user managing unit 54, the device managing unit 55, the license managing unit 56, and a group managing unit 60 are examples of the managing units.

The screen information generating unit 51, the tenant managing unit 53, the user managing unit 54, the device managing unit 55, and the license managing unit 56 correspond to functional blocks that execute processing in the management setting site 201, the tenant management system 202, the user management system 204, the device management system 205, and the license management system 206 of FIG. 3.

The second communication unit 52 transmits and receives various kinds of information to and from the terminal apparatus 10. For example, various kinds of screen information generated by the screen information generating unit 51 are transmitted to the terminal apparatus 10. Information input to these screens is received. The screen information generating unit 51 generates screen information according to the operation contents with respect to the terminal apparatus 10. The tenant managing unit 53 manages tenant information and stores and acquires tenant information in and from the tenant information storage unit 591. The user managing unit 54 manages the user information and performs registration of the user information to the user information storage unit 594 and acquisition (reading) of the user information from the user information storage unit 594. The device managing unit 55 manages device information and registers device information to the device information storage unit 595 and acquires (reads) device information from the device information storage unit 595. The license managing unit 56 receives an application contract and registers or acquires license information to and from the license information storage unit 596. Further, the license managing unit 56 manages the number of licenses and the expiry dates of licenses.

The authenticating unit 57 authenticates a tenant administrator, a general user, or the like, to determine whether the authentication is successful or unsuccessful. Authentication refers to the determination of whether a person requesting the authentication is a legitimate authorized person. In the present embodiment, the authentication is to determine whether a person has the right to use the information processing system 50 and to determine whether a person is a tenant administrator or a general user. Successful authentication means allowing the tenant administrator or general user to log in to the information processing system 50. Login refers to an authentication activity of accessing a system's resources by using the account information registered in advance, when using various services in a computer or on the Internet. The account information may be a user ID and a password, an merged circuit (IC) card number, or biometric authentication information. The application managing unit 58 manages each application, manages the default settings of the application for each user, and applies the default settings to the application.

The information processing system 50 includes a storage unit 59 implemented by the HD 504, the RAM 503, or the like illustrated in FIG. 4. The storage unit 59 includes a tenant information storage unit 591, a user information storage unit 594, a device information storage unit 595, a license information storage unit 596, and an application information storage unit 598.

Next, a database stored in the storage unit 59 will be described.

TABLE 1
TENANT INFORMATION

| ITEM | DESCRIPTION |
|---|---|
| TENANT ID | IDENTIFICATION INFORMATION OF |
| | TENANT |
| TENANT NAME | NAME, ETC., OF TENANT (NAME OF |
| | CUSTOMER) |
| REGISTRATION | REGISTRATION DATE OF TENANT |
| DATE | |

Table 1 schematically illustrates the tenant information stored in the tenant information storage unit 591. The tenant information includes fields that indicate items of a tenant name and a registration date associated with a tenant ID.
Tenant ID . . . Identification information of tenant.
Name of tenant . . . Name of tenant, such as a company name and a department name.
Registration date . . . Registration date of the tenant.

TABLE 2
USER INFORMATION

| ITEM | DESCRIPTION |
|---|---|
| TENANT ID | ID OF TENANT TO WHICH USER |
| | BELONGS |
| USER ID | U0123 |
| PASSWORD | x x x x x |
| SURNAME | Tokkyo |
| FIRST NAME | Taro |
| E-MAIL ADDRESS | taro@sample.com |
| DISPLAY | JAPANESE |
| LANGUAGE (LOCALE) | |
| STATE OF ACCOUNT | ENABLED OR DISABLED OR |
| | ACCOUNT LOCK |
| ROLE | ADMINISTRATOR OR GENERAL |
| | USER |
| APPLICATION USE | LIST OF APPLICATIONS |
| RIGHT | |

Table 2 schematically illustrates the user information stored in the user information storage unit 594. The user information is associated with the tenant ID. That is, there is user information corresponding to the number of users belonging to the tenant. User information in the user information storage unit includes information of a tenant administrator. The user information is registered by the tenant administrator by connecting to the information processing system 50.

The user information includes the items of a tenant ID, a user ID, a password, the surname, the first name, an e-mail address, the display language (locale), the state of the account, the role, and an application use right.
Tenant ID . . . Identification information of the tenant to which the user belongs.
User ID . . . Identification information of the user.
Password . . . Confidential information to prove the user.
Surname . . . Last name of the user.
First name . . . First name of the user.
E-mail address . . . The user's e-mail address.
Display language (locale) . . . The language of characters displayed on the screen used by the user.
State of account . . . An account is the right for the user to log in to the information processing system 50. There are at least three states of an account: enabled, disabled, or account lock. When user information is tentatively registered, the account becomes disabled, and by formally registering the user information, the account becomes enabled. The tenant administrator can disable the account after the account is enabled. Account lock is set when the user makes mistakes in inputting the password several times during the enabled state. Account lock differs from the disabled state, for example, in that the state returns to an enabled state after a certain period of time, or the user remains to be counted as a user belonging to a tenant.
Role . . . The user's authority. For example, there is “a tenant administrator or a general user”. In the present embodiment, the tenant administrator and the general user are referred to as the user.
Application use right . . . A list of applications available for use to the user. For example, this is information for identifying applications for which a use right is assigned by the tenant administrator, among the applications that are available for use to the tenant under a license contract.
The date and time when the user information is registered may be included in the user information.

TABLE 3
DEVICE INFORMATION

| ITEM | DESCRIPTION |
|---|---|
| TENANT ID | IDENTIFICATION INFORMATION OF |
| | TENANT USING DEVICE ON WHICH |
| | APPLICATION IS OPERATING |
| DEVICE ID | IDENTIFICATION INFORMATION FOR |
| | IDENTIFYING DEVICE |
| DISPLAY | DEFAULT LANGUAGE DISPLAYED BY |
| LANGUAGE | MENU, ETC. |
| STATE OF | ENABLED OR DISABLED OR ACCOUNT |
| ACCOUNT | LOCK |
| DEVICE TYPE | MFP, ELECTRONIC BLACKBOARD, ETC. |
| APPLICATION | LIST OF APPLICATIONS |
| USE RIGHT | |

Table 3 schematically illustrates device information stored in the device information storage unit 595. Device information includes the items of the device ID, the display language, the state of account, the device type, and the application use right, associated with the tenant ID.
Tenant ID . . . ID of the tenant using an electronic device in which the application operates.
Device ID . . . Identification information for identifying an electronic device.
Display language . . . The default language displayed by a menu, etc.
State of account . . . The state of the account, which may be enabled, disabled, or account lock.
Device type . . . The type of the electronic device such as an MFP, an electronic blackboard, and the like.
Application use right . . . A list of applications available for use to the electronic device. For example, this is information for identifying applications for which a use right is assigned by the tenant administrator, among the applications that are available for use to the tenant under a license contract.

TABLE 4
LICENSE INFORMATION

| ITEM | DESCRIPTION |
|---|---|
| TENANT ID | IDENTIFICATION INFORMATION OF TENANT |
| | THAT HAS PURCHASED LICENSE |
| LICENSE ID | IDENTIFICATION INFORMATION OF LICENSE |
| APPLICATION | IDENTIFICATION INFORMATION OF LICENSED |
| ID | APPLICATION |
| LICENSE NAME | NAME OF PURCHASED LICENSE |
| LICENSE TYPE | USER LICENSE OR DEVICE LICENSE |
| AUTOMATIC | ENABLED (AUTOMATICALLY GRANT USE |
| GRANT FLAG | RIGHT OF CORRESPONDING LICENSE TO |
| | USER) OR DISABLED (DO NOT |
| | AUTOMATICALLY GRANT USE RIGHT OF |
| | CORRESPONDING LICENSE TO USER) |
| NUMBER OF | 100 |
| LICENSES | |

Table 4 schematically illustrates the license information stored in the license information storage unit 596. The license information includes items of the tenant ID, the license ID, the application ID, the license name, the license type, the automatic grant flag, and the number of licenses.
Tenant ID . . . Identification information of the tenant that has purchased the license.
License ID . . . Identification information of the license.
Application ID . . . Identification information of a licensed application.
License name . . . Name of the purchased license. The license name may have a function of identifying a license. A license is associated with an application by the license name.
License type . . . The license type is registered to indicate as to whether the contract is on a per user basis or on a per electronic device basis. The license type may be registered to indicate as to whether the contract is a trial plan or a formal plan. If the contract is on a per user basis, the license is also referred to as a user license, and the user right to use the application can be set for the user. If the contract is on a per device basis, the license is also referred to as a device license, and the use right to use the application can be set for the device.
Automatic grant flag . . . Enabled (automatically grant the use right of an application) or disabled (do not automatically grant a use right of an application) is registered.
Number of licenses . . . The number of licenses (the number of users who can use the application, the number of electronic devices that can use the application, or both). If the type of license is on a per user basis, the number of licenses is the upper limit of the number of users to whom the use right can be assigned. If the type of license is on a per device basis, the number of licenses is the upper limit of the number of devices to which the use right can be assigned. For example, the administrator of the license or group can assign a use right to users or devices belonging to a tenant or a group, with the number of licenses being the upper limit. Here, when the administrator enters into a purchase contract of an application license, the administrator can specify the number of licenses to be purchased. The license information may include information for identifying the user or the device to which the use right has been assigned, based on the license.

TABLE 5
APPLICATION INFORMATION

| ITEM | DESCRIPTION |
|---|---|
| TENANT ID | IDENTIFICATION INFORMATION OF TENANT |
| | USING APPLICATION |
| APPLICATION | IDENTIFICATION INFORMATION OF |
| ID | APPLICATION |
| ROLE | TENANT ADMINISTRATOR OR GENERAL |
| | USER |

Table 5 schematically illustrates the application information stored in the application information storage unit 598. The application information includes the items of an application ID and a role associated with a tenant ID. The application information is registered by the person in charge of business according to the contract status of a service. The application information may be registered automatically according to the service contract.
Tenant ID . . . Identification information of a tenant using the application.
Application ID . . . Identification information of application.
Role . . . The authority of the user who can use an application. For example, there is a “tenant administrator or a general user”. As the roles, the role of the user who can use the function provided by the application and the role of the user who can assign the use right of an application, may be stored.

Note that tables 1 to 5 are only illustrated for the purpose of explaining the present embodiment, and information that is not the main information is omitted.

### <Group Management Function of Tenant Management Unit>

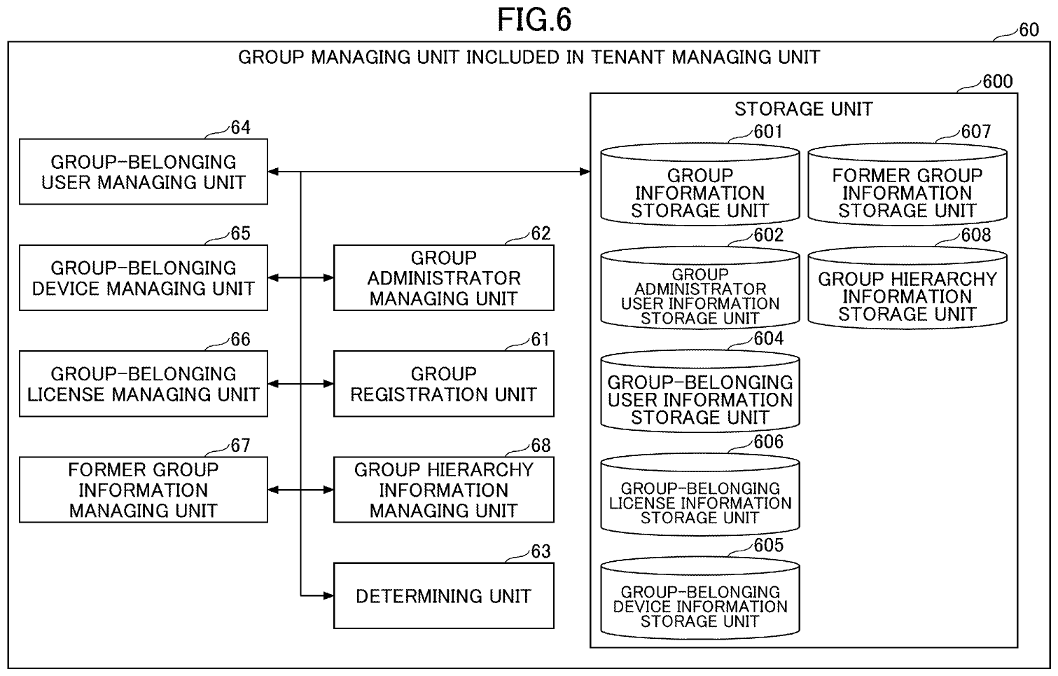

Next, the group management function will be described with reference to FIG. 6. FIG. 6 is an example of a functional block diagram explaining the functions of the group managing unit 60 divided into blocks. As illustrated in FIG. 5, the group managing unit 60 is included in the tenant managing unit 53.

The group managing unit 60 includes a group-belonging user managing unit 64, a group-belonging device managing unit 65, a group-belonging license managing unit 66, a group administrator managing unit 62, a group registration unit 61, a former group information managing unit 67, a group hierarchy information managing unit 68, a determining unit 63, and a storage unit 600.

The group-belonging user managing unit 64 accepts the registration of the user 401 belonging to a group and registers the user in a group-belonging user information storage unit 604. The information of the user 401 belonging to the group is acquired from the group-belonging user information storage unit 604.

The group-belonging device managing unit 65 accepts the registration of the electronic device 40 belonging to a group and registers the electronic device 40 in a group-belonging device information storage unit 605. Further, information of the electronic device 40 belonging to the group is acquired from the group-belonging device information storage unit 605.

The group-belonging license managing unit 66 accepts the registration of the license belonging to a group and registers the license in a group-belonging license information storage unit 606. Further, information of the license belonging to the group is acquired from the group-belonging license information storage unit 606. For example, if the tenant administrator enters into a contract to purchase a license of an application, the tenant administrator may assign the use right to use the application corresponding to the license, to users or devices belonging to the tenant within the limit of the number of licenses purchased. Then, the user or the device to which the use right has been is assigned can use the function of the application corresponding to the use right. At this time, the tenant administrator may register the license with respect to a group belonging to the tenant. When a license is registered with respect to a group, users or devices belonging to the group can be assigned a use right within the limit of the number of licenses. If the total number of use rights assigned to users or devices is less than upper limit of the number of licenses, assignment of the unassigned use rights can be suspended, and can be assigned at any timing. Further, if a license is assigned to a group, users or devices belonging to other groups cannot be assigned a use right based on the license. The tenant administrator is able to assign all of or part of the number of licenses to the group as use rights. In this case, users or devices belonging to the group can be assigned a use right within the limit of the number of assigned licenses. The license ID for identifying the license assigned to the group and the number of licenses may be stored in the group-belonging license information storage unit 606. Further, although a description has been given of a case where the tenant administrator purchases the license of the application, a group administrator may purchase the license of the application. In this case, the use right to use the application can be set within the limit of the number of licenses purchased for the group that is managed by the group administrator.

The group administrator managing unit 62 accepts the registration of a group administrator and registers the group administrator in a group administrator user information storage unit 602. The information of the group administrator is acquired from the group administrator user information storage unit 602.

The group registration unit 61 accepts the group registration and registers the group in a group information storage unit 601. The information of the group is acquired from the group information storage unit 601.

The determining unit 63 makes various determinations. For example, the determining unit 63 determines the group 404 to which a certain user 401 or electronic device 40 belongs. When a plurality of groups are merged, the determining unit 63 can determine which user or device can be preferentially assigned a use right based on the license assigned before the merger of the groups, among the users or devices belonging to the group after the merger, and perform a process of assigning a use right to a user or a device.

Next, a database held by the group management system 203 in the storage unit 600 will be described.

TABLE 6
GROUP INFORMATION

| ITEM | DESCRIPTION |
|---|---|
| TENANT ID | IDENTIFICATION INFORMATION OF |
| | TENANT USING APPLICATION |
| GROUP ID | IDENTIFICATION INFORMATION OF |
| | GROUP IN TENANT |
| GROUP NAME | ABC DEPARTMENT |

Table 6 schematically illustrates group information stored in the group information storage unit 601. The group information includes a tenant ID, a group name, and a group ID.
Tenant ID . . . Identification information of a tenant in which the group 404 is created.
Group ID . . . Identification information of the group 404.
Group name . . . Name of the group 404. The tenant administrator assigns any department name or team name.

TABLE 7
GROUP ADMINISTRATOR USER INFORMATION

| ITEM | DESCRIPTION |
|---|---|
| GROUP ID | IDENTIFICATION INFORMATION OF GROUP IN |
| | TENANT |
| USER NAME | U0123 |

Table 7 schematically illustrates the group administrator user information stored in the group administrator user information storage unit 602. The group administrator user information includes a group ID and a user ID of the group administrator user.
Group ID . . . Identification information of the group 404.
User ID of the group administrator user . . . Identification information of the user 401 registered as the group administrator.

TABLE 8
GROUP-BELONGING USER INFORMATION

| ITEM | DESCRIPTION |
|---|---|
| GROUP ID | IDENTIFICATION INFORMATION OF GROUP IN |
| | TENANT |
| USER ID | U0123 |

Table 8 schematically illustrates the group-belonging user information stored in the group-belonging user information storage unit 604. The group-belonging user information includes a group ID and a user ID of the user 401 belonging to the group 404.
Group ID . . . Identification information of the group 404.
User ID of the user 401 belonging to the group 404 . . . Identification information of the user 401 registered in the group 404.

TABLE 9
GROUP-BELONGING DEVICE INFORMATION

| ITEM | DESCRIPTION |
|---|---|
| GROUP ID | IDENTIFICATION INFORMATION OF GROUP IN |
| | TENANT |
| DEVICE ID | IDENTIFICATION INFORMATION FOR IDENTIFYING |
| | DEVICE |

Table 9 schematically illustrates group-belonging device information stored in the group-belonging device information storage unit 605. The group-belonging device information includes a group ID and a device ID of the electronic device 40 belonging to the group 404.
Group ID . . . Identification information of the group 404.
Device ID of the electronic device 40 belonging to the group 404 . . . Identification information of the electronic device 40 registered in the group 404.

TABLE 10
GROUP-BELONGING LICENSE INFORMATION

| ITEM | DESCRIPTION |
|---|---|
| GROUP ID | IDENTIFICATION INFORMATION OF GROUP IN |
| | TENANT |
| LICENSE ID | IDENTIFICATION INFORMATION OF LICENSE |

Table 10 schematically illustrates the group-belonging license information stored in the group-belonging license information storage unit 606. The group-belonging license information includes a group ID and a license ID of the license 402 belonging to the group 404.
Group ID . . . Identification information of the group 404.
License ID of the license 402 belonging to the group 404 . . . Identification information of the license 402 registered in the group.

TABLE 11
FORMER GROUP INFORMATION

| ITEM | DESCRIPTION |
|---|---|
| GROUP ID | IDENTIFICATION INFORMATION OF GROUP IN |
| | TENANT |
| FORMER | IDENTIFICATION INFORMATION OF GROUP IN |
| GROUP ID | TENANT BEFORE MERGER |

Table 11 schematically illustrates the former group information stored in a former group information storage unit 607. The former group information includes fields that indicate a group ID of the group 404 to which the user, etc., currently belongs, and the group ID of the former group to which the user, etc., formally belonged before the merger.
Group ID . . . Identification information of the group 404 to which the user, etc., currently belongs.
Former group ID . . . Identification information of a former group to which the user, etc., belonged before the merger. That is, this information is used to identify which groups have been merged to form the group after the merger indicated by the group ID. When a new group is created by merging multiple groups, the former group ID field includes multiple group IDs.

TABLE 12
GROUP HIERARCHY MANAGEMENT INFORMATION

| ITEM | DESCRIPTION |
|---|---|
| GROUP ID | IDENTIFICATION INFORMATION OF GROUP IN |
| | TENANT |
| PARENT | IDENTIFICATION INFORMATION OF GROUP IN |
| GROUP ID | PARENT TENANT |
| CHILD | IDENTIFICATION INFORMATION OF GROUP IN |
| GROUP ID | CHILD TENANT |

Table 12 schematically illustrates group hierarchy information stored in a group hierarchy information storage unit 608. The group hierarchy information includes a group ID, a parent group ID, and a child group ID.
Group ID . . . Identification information of the group 404.
Parent group ID . . . ID of a parent group.
Child group ID . . . ID of a child group.

### <Problem to be Solved by the First Embodiment>

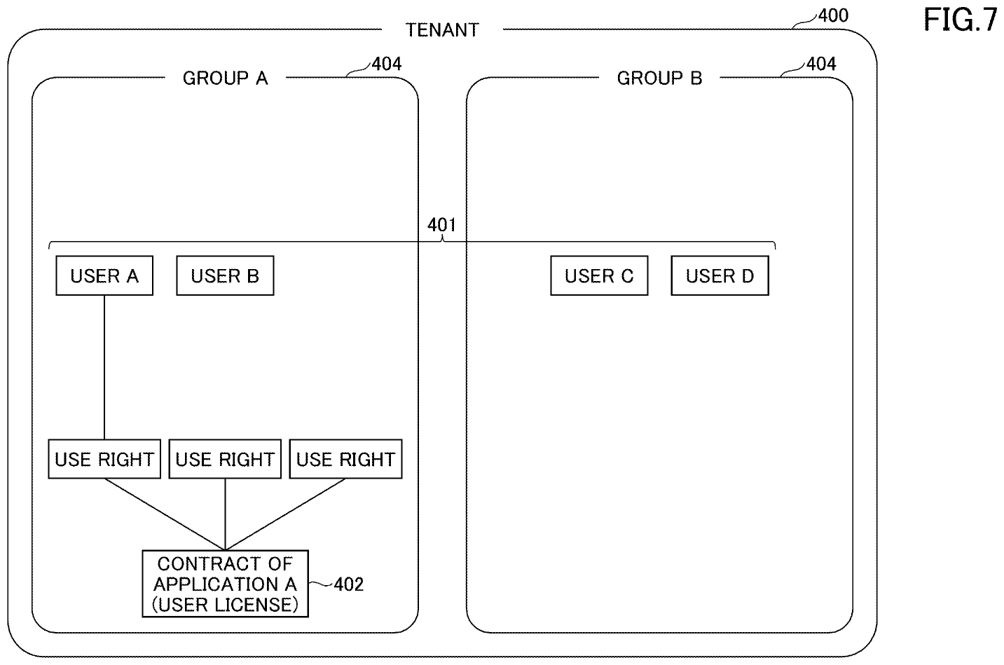

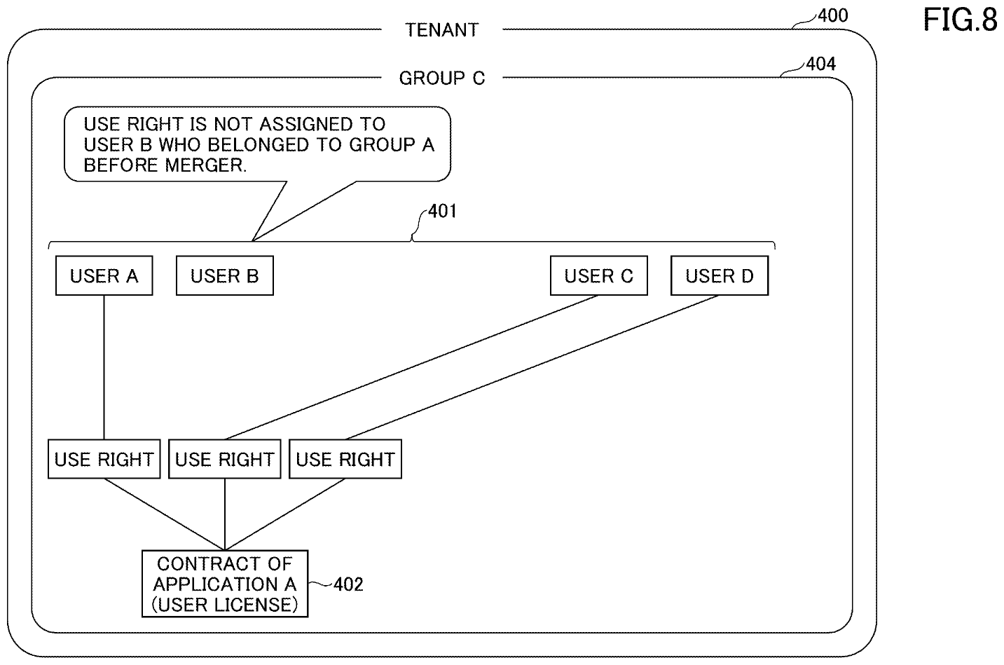

A problem to be solved in the present embodiment will be described with reference to FIGS. 7 and 8. As illustrated in FIG. 7, there are two groups 404 in the tenant 400, specifically, group A to which a user A and a user B belong, and group B to which a user C and a user D belong. Group A owns use rights for three users as the license 402 for using application A, and one use right is assigned to the user A. That is, a license including three licenses for application A is purchased in advance by the tenant administrator, and the license is assigned to group A. The application A is owned by group A, and, therefore, the remaining two unassigned use rights cannot be assigned to user C and user D of group B. Here, group A is an example of group 1 and group B is an example of group 2.

Here, consideration is made on how to handle the use rights to use application A when group A and group B are merged to form group C. As illustrated in FIG. 8, according to the group merger, the use rights of application A will be owned by group C, thereby allowing the use rights to be assigned to all of the users of group C. Accordingly, when the user C and the user D are assigned the use rights in addition to the user A, use rights for three users will be assigned, and, therefore, a problem arises in that a use right cannot be assigned to the user B. Originally, the license 402 for application A has been owned by group A, and, therefore, it is necessary to manage the use rights such that a use right can be assigned to the user B who belonged to group A before the merger. Here, a case in which a third group, i.e., group C, is created by merging group A and group B is described. However, the merger is not limited thereto; for example, there may be a case in which a new group A is created by merging group B into group A.

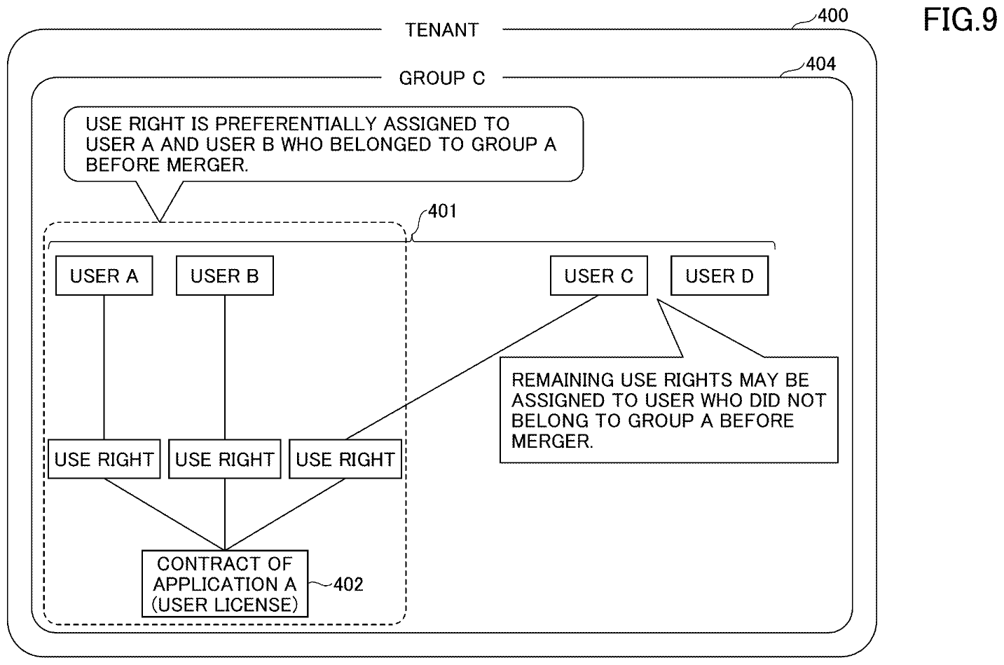

In order to solve this problem, in the present embodiment, as illustrated in FIG. 9, the use rights can be managed such that the user A and the user B who belonged to group A before the merger can be preferentially assigned the use rights of application A. User C and user D who did not belong to group A before the merger are allowed to be assigned a use right only when there is a surplus of use rights.

### <Process Performed in the First Embodiment>

A process performed in the first embodiment will be described. First, the process of merging group A and group B within a tenant will be described. The tenant administrator operates the terminal apparatus 10 to access the management setting site 201 and performs group merger by using the functions of the group management system 203 in the tenant management system 202.

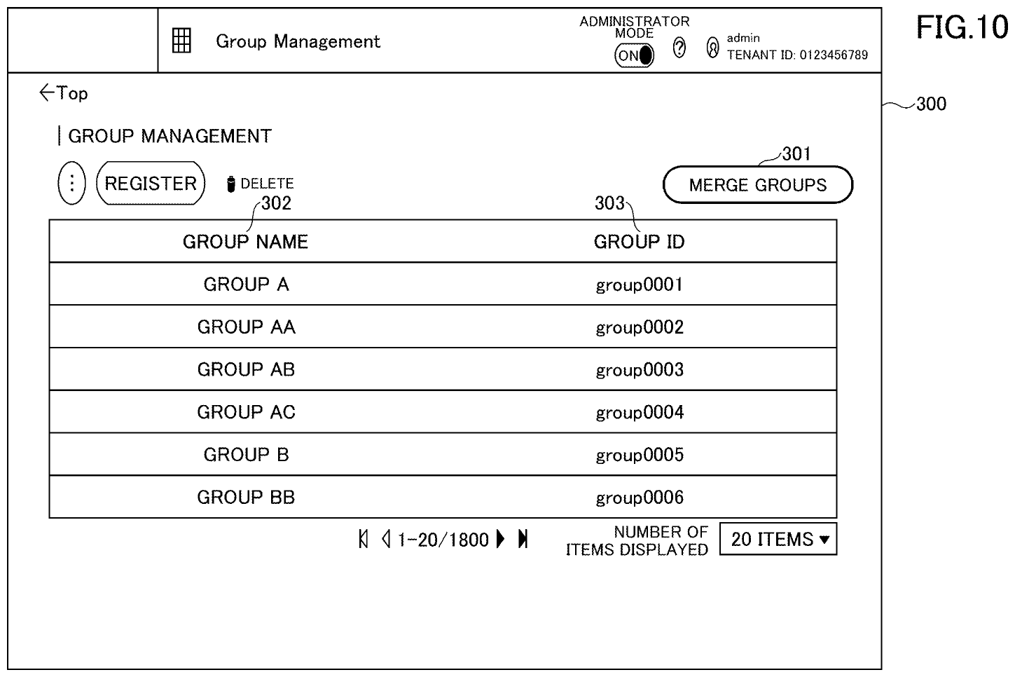

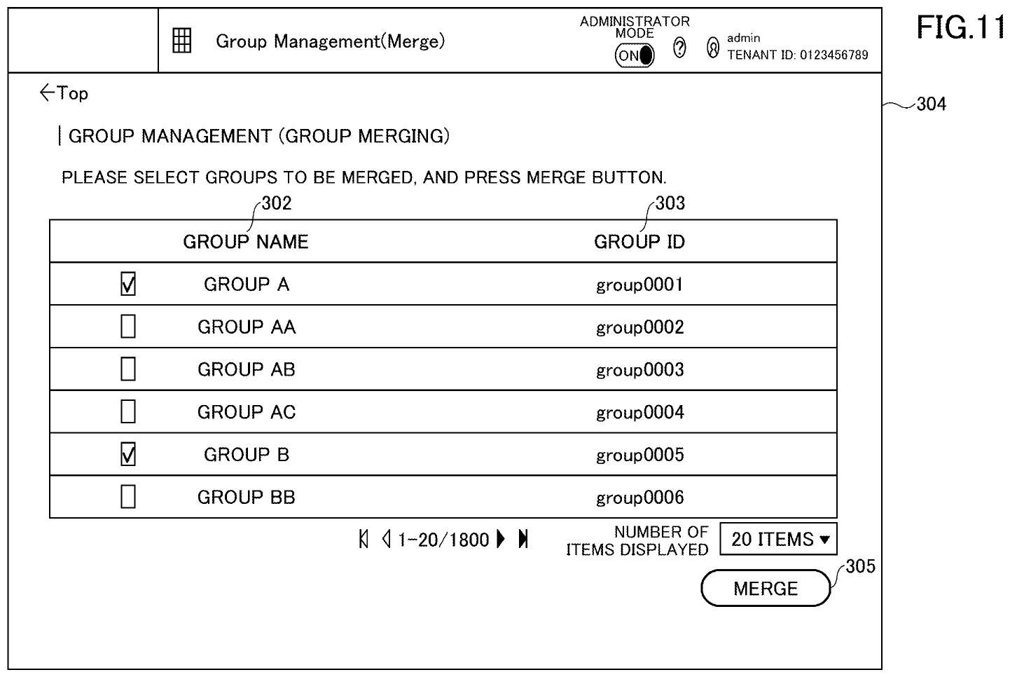

Specifically, when it is determined that the tenant administrator has a tenant ID and the administrator right by logging in to the information processing system 50, the screen information generating unit 51 transmits the administrator's home screen to the terminal apparatus 10. The tenant administrator performs an operation on the home screen to open the group management screen, and the operation accepting unit 14 of the terminal apparatus 10 accepts the operation. In this way, when the screen transitions to a “group management screen” 300 illustrated in FIG. 10, a button “merge groups” 301 is displayed along with a list of group names 302 and corresponding group IDs 303. Furthermore, when the button “merge groups” 301 is pressed, the screen transitions to a “group management (group merge) screen 304” illustrated in FIG. 11. Here, the tenant administrator selects group A and group B and presses a button of merge 305. Then, by inputting a group name (group C) after merger, the information processing system 50 executes a group merging process. For example, when the button of merge 305 is pressed, a screen including a text box for inputting a group name is displayed, and the group name after the merger can be set by inputting a group name to the screen. The groups to be merged may be selected from two or more groups.

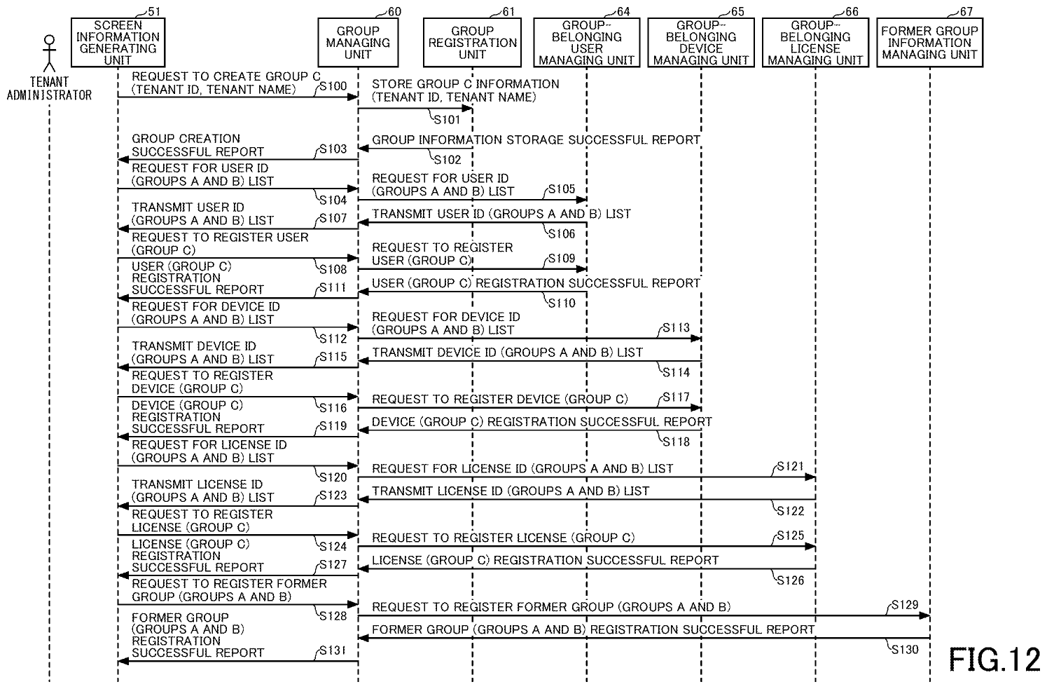

Next, the group merging process performed by the information processing system 50 will be described with reference to FIG. 12. FIG. 12 is a sequence diagram illustrating an example of a group merging process.

S100: The screen information generating unit 51 transmits a message requesting group merger to the group managing unit 60. The request message includes the tenant ID of the tenant administrator, the group IDs of the groups to be merged (group A and group B), and the group name after the merger (group C) input by the tenant administrator.

S101: The group managing unit 60 creates group C by using the information included in the received request message and transmits the group information of the created group C to the group registration unit 61.

S102: The group registration unit 61 stores the received group information of group C in the group information storage unit 601 and transmits a group information storage successful report, to the group managing unit 60.

S103: The group managing unit 60 transmits a group information creation successful report to the screen information generating unit 51.

S104: The screen information generating unit 51 transmits a message requesting the group managing unit 60 to provide a list of user IDs of the users belonging to group A and group B.

S105: The group managing unit 60 transmits the received request message to the group-belonging user managing unit 64.

S106: The group-belonging user managing unit 64 acquires the requested list of user IDs from the group-belonging user information storage unit 604 and transmits the list to the group managing unit 60.

S107: The group managing unit 60 transmits the received list of user IDs to the screen information generating unit 51.

S108: The screen information generating unit 51 transmits, to the group managing unit 60, a request message for registering, in group C, the user IDs in the received user ID list.

S109: The group managing unit 60 transmits the received request message to the group-belonging user managing unit 64.

S110: The group-belonging user managing unit 64 stores, in the group-belonging user information storage unit 604, the information of registering the user ID in group C based on the received request message, and transmits a registration successful report to the group managing unit 60.

S111: The group managing unit 60 transmits the registration successful report to the screen information generating unit 51.

S112: The screen information generating unit 51 transmits a message requesting the group managing unit 60 to provide a device ID list of devices belonging to group A and group B.

S113: The group managing unit 60 transmits the received request message to the group-belonging device managing unit 65.

S114: The group-belonging device managing unit 65 acquires the requested device ID list from the group-belonging device information storage unit 605 and transmits the list to the group managing unit 60.

S115: The group managing unit 60 transmits the received device ID list to the screen information generating unit 51.

S116: The screen information generating unit 51 transmits, to the group managing unit 60, a request message for registering, in group C, the device ID in the received device ID list.

S117: The group managing unit 60 transmits the received request message to the group-belonging device managing unit 65.

S118: The group-belonging device managing unit 65 stores, in the group-belonging device information storage unit 605, the information of registering the device ID in group C, based on the received request message, and transmits a registration successful report to the group managing unit 60.

S119: The group managing unit 60 transmits the registration successful report to the screen information generating unit 51.

S120: The screen information generating unit 51 transmits a message requesting the group managing unit 60 to provide a list of the license IDs of the licenses belonging to group A and group B.

S121: The group managing unit 60 transmits the received request message to the group-belonging license managing unit 66.

S122: The group-belonging license managing unit 66 acquires the requested license ID list from the group-belonging license information storage unit 606 and transmits the list to the group managing unit 60.

S123: The group managing unit 60 transmits the received license ID list to the screen information generating unit 51.

S124: The screen information generating unit 51 transmits, to the group managing unit 60, a request message for registering, in group C, the license ID in the received license ID list.

S125: The group managing unit 60 transmits the received request message to the group-belonging license managing unit 66.

S126: The group-belonging license managing unit 66 stores, in the group-belonging license information storage unit 606, the information of registering the license ID in group C based on the received request message, and transmits a registration successful report to the group managing unit 60.

S127: The group managing unit 60 transmits the registration successful report to the screen information generating unit 51.

S128: The screen information generating unit 51 transmits a message requesting to register groups A and B as the former groups of group C, to the group managing unit 60.

S129: The group managing unit 60 transmits the received request message to the former group information managing unit 67.

S130: The former group information managing unit 67 stores, in the former group information storage unit 607, information for registering group A and group B as the former groups of group C, based on the received request message, and transmits a registration successful report to the group managing unit 60.

S131: The group managing unit 60 transmits a registration successful report to the screen information generating unit 51.

By the above-described process, the information processing system 50 registers information relating to users, devices, and licenses of groups A and B before the merger, as information of group C, and also registers information indicating that groups A and B are former groups of group C. Here, even after group A and group B are merged, the group-belonging user information, the group-belonging device information, and the group-belonging license information corresponding to groups A and B, are stored without being deleted.

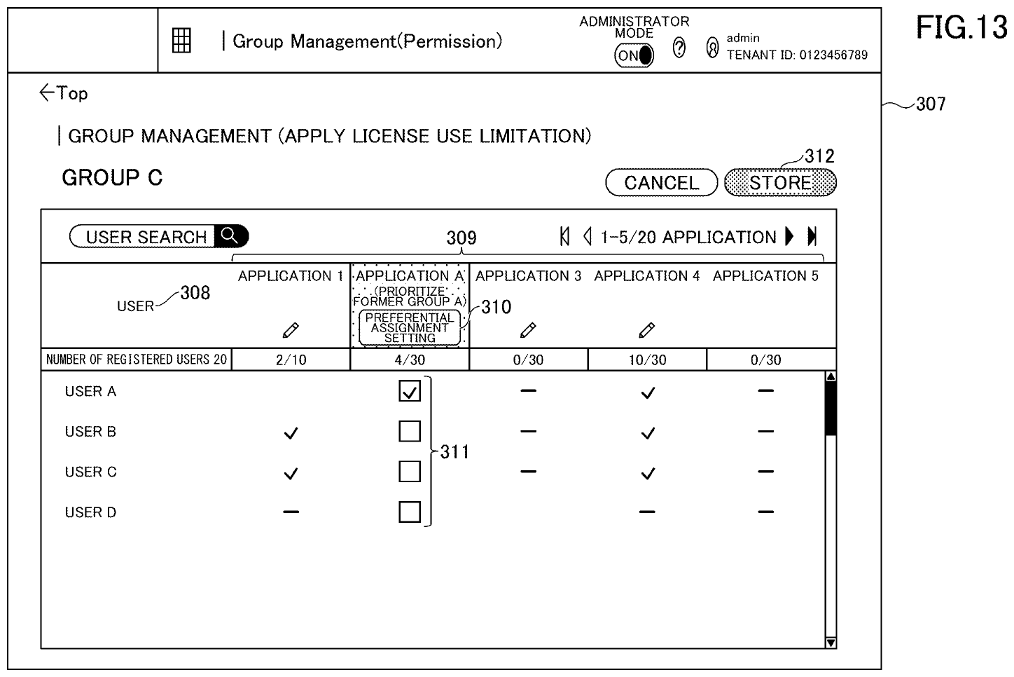

Next, a process of preferentially assigning the use right to use application A owned by group A, to the users who belonged to group A, will be described. The same process as that performed for a user can be performed for a device. Similar to the above-described group merging process, the tenant administrator operates the terminal apparatus 10 to access a “group management screen” 307 illustrated in FIG. 13 and assign the use rights for an application 309 available for use to users 308 belonging to group C. The “group management screen” 307 is in a state of performing a “use right assignment setting” 311 of application A for each of the users 308, and only the user A is granted the use right. After changing the “use right assignment setting” 311, by pressing a “store” button 312, the setting can be stored. Further, by pressing the button of “preferential assignment setting” 310, it is possible to make a setting of preferentially assigning a use right for a user who belonged to the former group. Currently, application A is set to preferentially assign use rights to users who belonged to former group A.

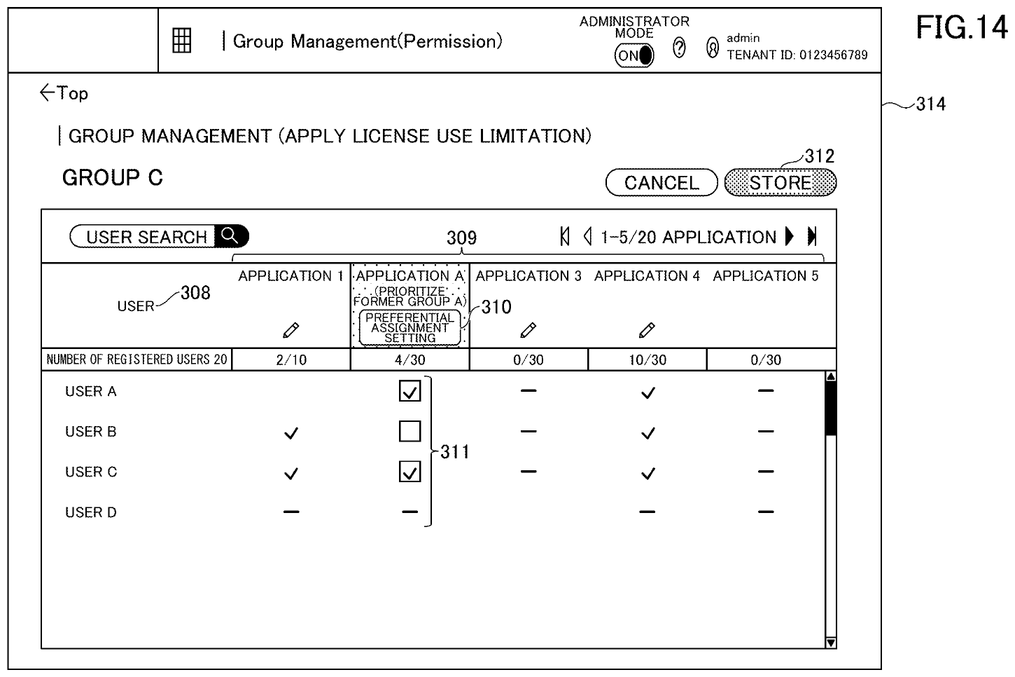

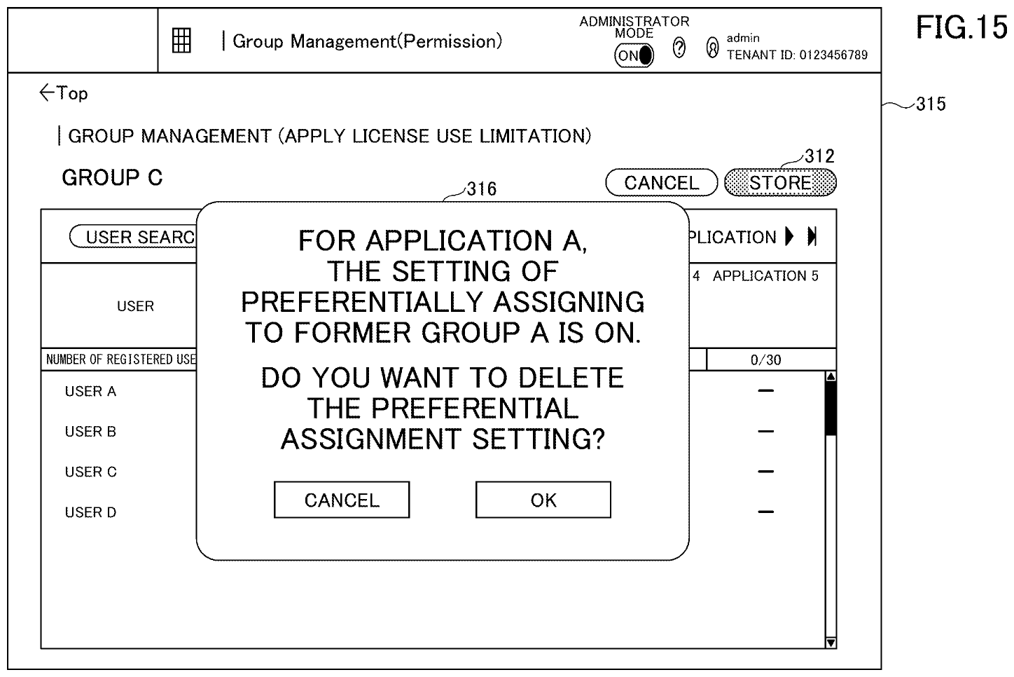

With respect to application A, two more use rights can be assigned to users. For example, as illustrated in FIG. 14, when the user C is assigned a use right, the remaining one use right is preferentially assigned to the user B who belonged to former group A. That is, in the “use right assignment setting” 311, “-” is displayed for the user D, so that the use right cannot be assigned to users other than those who belonged to former group A. In this case, check boxes may be deleted such that the use right of application A is not assigned users who belonged to former group B. However, the check boxes corresponding to the users who have already been assigned the use rights, are displayed in a selectable manner, so that the assignment of the use right of application A can be cancelled. By selecting a check box that is checked, the use right of application A assigned to the corresponding user can be cancelled. For example, in the group management screen illustrated in FIG. 14, when the check box corresponding to the user C is selected, the check is removed from the check box corresponding to the user C, and further, the check box by which the user D can be assigned the use right is re-displayed, as illustrated in the group management screen illustrated in FIG. 13. Further, by pressing “preferential assignment setting” 310 again, as illustrated in FIG. 15, the setting of the preferential assignment can be deleted. When the setting of preferential assignment is cancelled, users other than those who belonged to former group A can be assigned a use right.

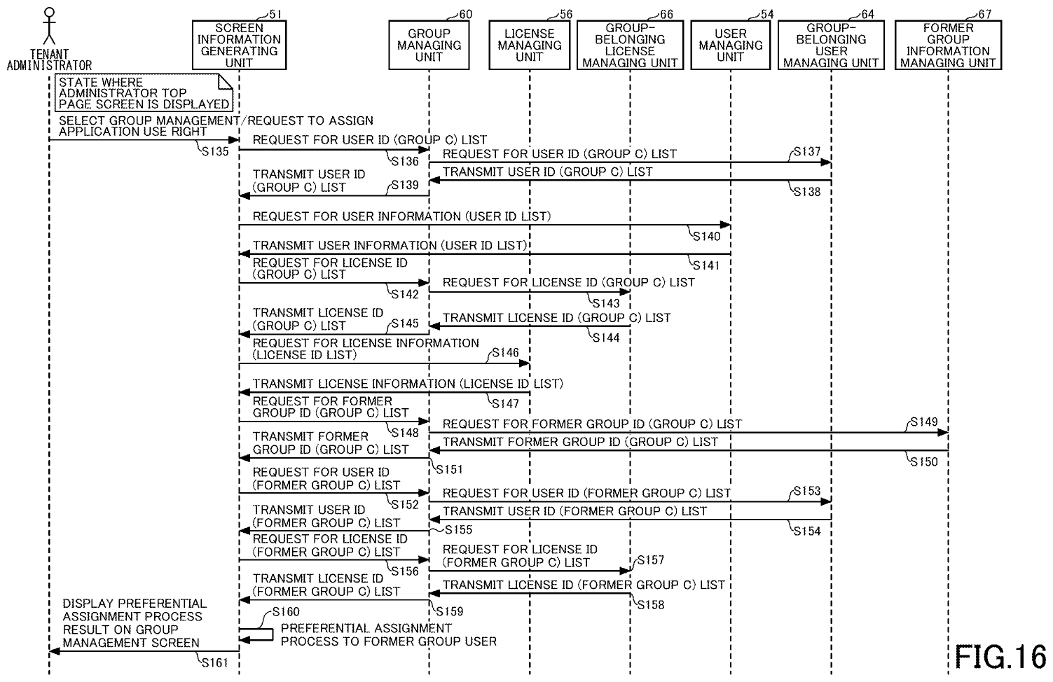

Next, the process of preferentially assigning the use rights for an application executed by the information processing system 50 will be described with reference to FIG. 16. FIG. 16 is a sequence diagram illustrating an example of a process of preferentially assigning the use right of an application.

S135: The tenant administrator operates the terminal apparatus 10 to transmit a message requesting the assignment of a use right of an application, from the group management screen to the screen information generating unit 51.

S136: The screen information generating unit 51 transmits a message requesting the group managing unit 60 to provide a list of user IDs of users belonging to group C.

S137: The group managing unit 60 transmits the received request message to the group-belonging user managing unit 64.

S138: The group-belonging user managing unit 64 acquires the requested list of user IDs from the group-belonging user information storage unit 604 and transmits the list to the group managing unit 60.

S139: The group managing unit 60 transmits the received list of user IDs to the screen information generating unit 51.

S140: The screen information generating unit 51 transmits a message requesting the user managing unit 54 to provide user information (application use right assignment) of each user in the received user ID list.

S141: The user managing unit 54 acquires the requested user information from the user information storage unit 594 and transmits the requested user information to the screen information generating unit 51.

S142: The screen information generating unit 51 transmits a message requesting the group managing unit 60 to provide a list of license IDs of the licenses belonging to group C.

S143: The group managing unit 60 transmits the received request message to the group-belonging license managing unit 66.

S144: The group-belonging license managing unit 66 acquires the requested license ID list from the group-belonging license information storage unit 606 and transmits the list to the group managing unit 60.

S145: The group managing unit 60 transmits the received license ID list to the screen information generating unit 51.

S146: The screen information generating unit 51 transmits a message requesting the license managing unit 56 to provide license information (the number of licenses) of each license in the received license ID list.

S147: The license managing unit 56 acquires the requested license information from the license information storage unit 596 and transmits the requested license information to the screen information generating unit 51.

S148: The screen information generating unit 51 transmits a message requesting the group managing unit 60 to provide former group information registered in group C.

S149: The group managing unit 60 transmits the received request message to the former group information managing unit 67.

S150: The former group information managing unit 67 acquires the requested former group information from the former group information storage unit 607 and transmits the requested former group information to the group managing unit 60.

S151: The group managing unit 60 transmits the received former group information to the screen information generating unit 51. Here, the former group information is information of the former groups (group A and group B) of group C.

S152: The screen information generating unit 51 transmits a message requesting the group managing unit 60 to provide a list of user IDs of users belonging to the former groups (group A and group B) of group C.

S153: The group managing unit 60 transmits the received request message to the group-belonging user managing unit 64.

S154: The group-belonging user managing unit 64 acquires the requested list of user IDs from the group-belonging user information storage unit 604 and transmits the list to the group managing unit 60.

S155: The group managing unit 60 transmits the received list of user IDs to the screen information generating unit 51.

S156: The screen information generating unit 51 transmits a message requesting the group managing unit 60 to provide a list of the license IDs of the licenses belonging to the former groups (group A and group B) of group C.

S157: The group managing unit 60 transmits the received request message to the group-belonging license managing unit 66.

S158: The group-belonging license managing unit 66 acquires the requested license ID list from the group-belonging license information storage unit 606 and transmits the list to the group managing unit 60.

S159: The group managing unit 60 transmits the received license ID list to the screen information generating unit 51.

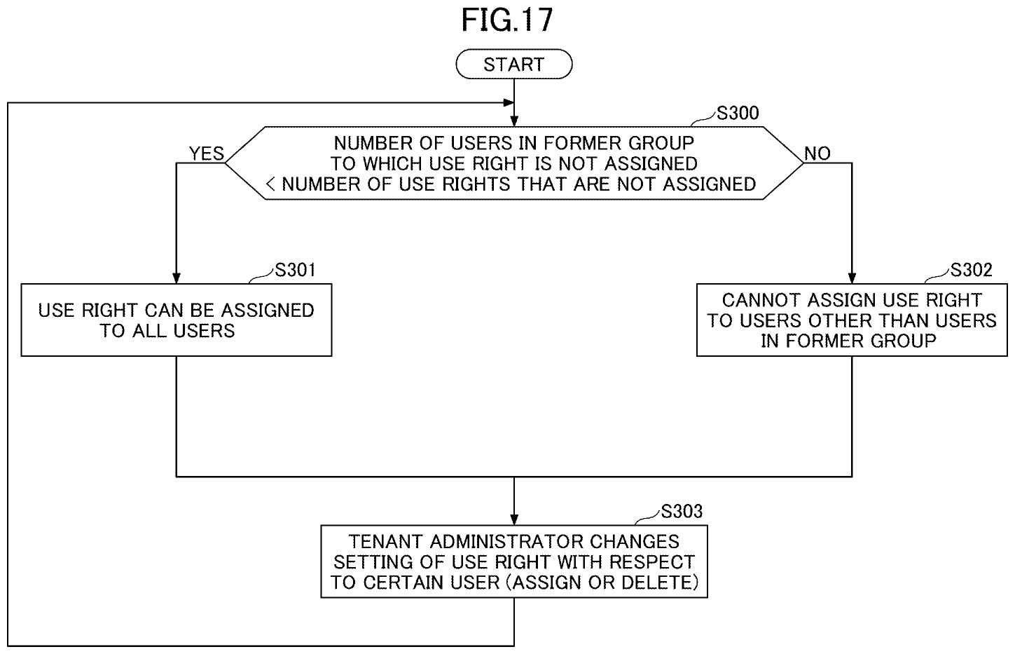

S160: The screen information generating unit 51 performs a process of preferentially assigning the license (the use right to use application A) owned by the former group (group A) of group C, to the user belonging to the former group. A flowchart diagram illustrated in FIG. 17 will be used to explain the details of this process. This process may be performed by the determining unit 63 in the group managing unit 60. Further, this process can be executed whenever the tenant administrator changes the assignment of a use right to user on the group management screen.

S300: If the number of users who belonged to former group A, who have not been assigned the use right to use application A owned by former group A, is smaller than the number of the use rights to use application A that have not been assigned, the process proceeds to S301. Otherwise, the process proceeds to S302.

Specifically, the determining unit 63 identifies the user IDs of all the users belonging to group A based on the group-belonging user information corresponding to group A. Next, by searching the user information corresponding to the identified user ID and referring to the application use right included in the corresponding user information, it is determined whether a use right to use application A is granted for each user. Then, the total number of the users who have not been granted the use right to use application A, among the users belonging to group A, is calculated. Thus, it is possible to calculate the number of users belonging to former group A who have not been assigned the use right to use application A.

In parallel, the determining unit 63 identifies the license ID assigned to group A based on the group-belonging license information corresponding to group A. Here, for example, it is assumed that the license ID corresponding to application A is identified. Next, by searching the license information corresponding to the identified license ID, the license information corresponding to application A can be identified. Further, the user or device to which use right has been assigned based on the license of application A, is identified. For example, the application use right included in the user information of the user or the device information of the device belonging to group A is referenced. When an application ID identifying an application A is included in the application use right, it can be determined that the use right for using application A is assigned to the corresponding user or device. Next, by calculating the difference between the number of licenses included in the identified license information and the total number of users or devices to which use right is assigned based on the license, it is possible to calculate the number of unassigned use rights for application A.

The determining unit 63 calculates the difference between the number of unassigned use rights for application A and the number of users belonging to former group A to which the use right for application A has not been assigned. If the difference is 1 or more, the process proceeds to S301. Otherwise, the process proceeds to S302.

S301: The use rights are made available to be assigned to all users in the group. That is, the display of the group management screen is controlled so that the tenant administrator can assign the use right for application A to both the users who belonged to former group A and the users who belonged to former group B. For example, a selectable check box is displayed for the user C in the “use right assignment setting” 311 illustrated in FIG. 13.

S302: The use right for application A is made unavailable to be assigned to users other than those who belonged to former group A. For example, “-” is displayed for the user D in the “use right assignment setting” 311 as illustrated in FIG. 14.

S303: If the tenant administrator has changed the setting of the use right for a particular user, that is, the tenant administrator has newly assigned a use right has or deleted the assigned use right, the process returns to S300.

Referring back to the sequence diagram of FIG. 16, the explanation will be continued.

S161: The screen information generating unit 51 generates a group management screen in which the result of the preferential assignment process is applied, and transmits the screen to the terminal apparatus 10.

As described above, according to the first embodiment of the present invention, information relating to the use right to use a service assigned prior to the group merger can be retained and managed so that the service can be used even after the group merger.

### Second Embodiment

In the first embodiment, after group A and group B are merged into group C, the user information and the license information are shared between the groups before the merger.

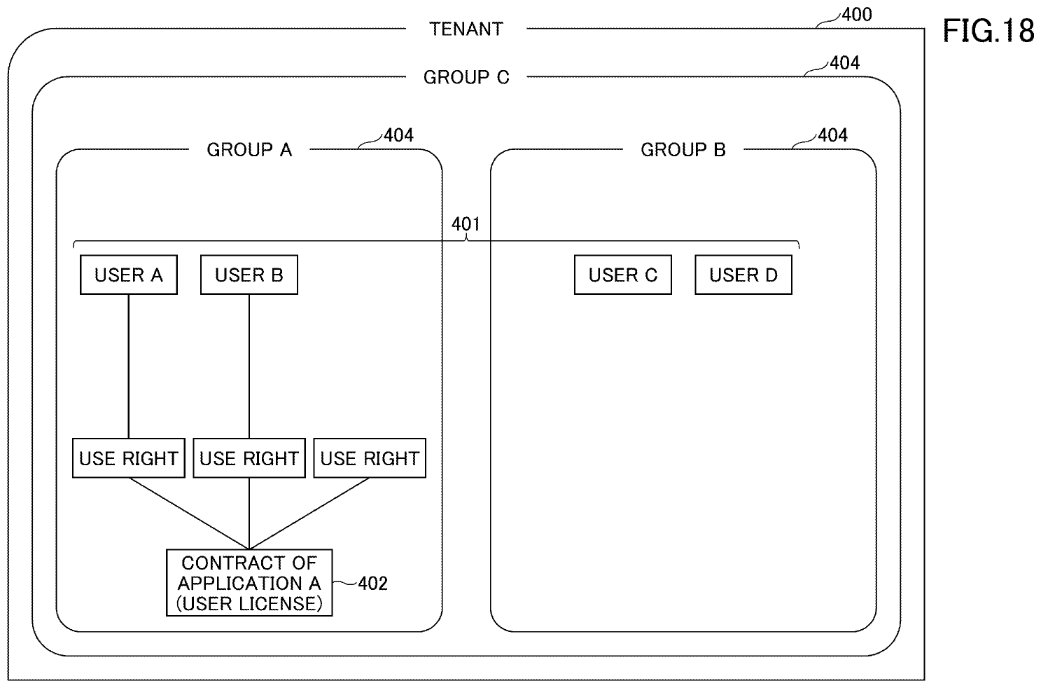

In the second embodiment, as illustrated in FIG. 18, groups A and B are hierarchically merged as child groups of group C, and user information and license information are not shared between the groups before the merger and the parent group C after the merger, and the use rights for a service are not shared as well.

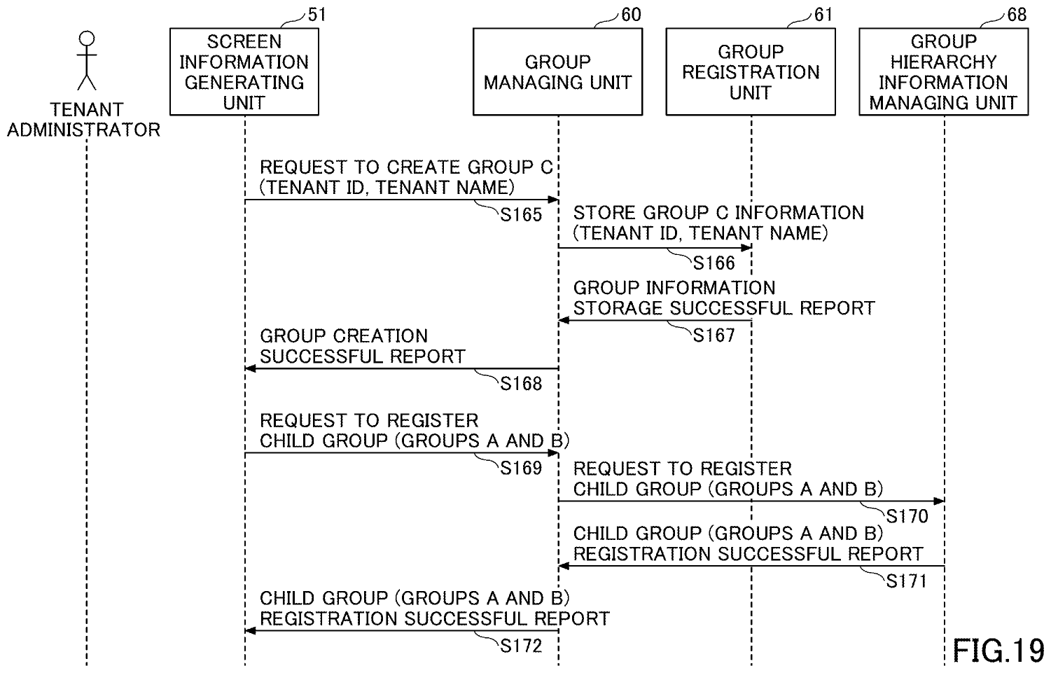

In the present embodiment, the group merging process performed by the information processing system 50 will be described with reference to FIG. 19. FIG. 19 is a sequence diagram illustrating an example of a group merging process.

S165: The screen information generating unit 51 transmits a message requesting the merger of the groups according to a hierarchical structure, to the group managing unit 60. The request message includes the tenant ID of the tenant administrator, the group IDs of the groups to be merged (group A and group B), and the group name after the merger (group C) input by the tenant administrator.

S166: The group managing unit 60 creates group C by using the information included in the received request message and transmits the group information of the created group C to the group registration unit 61.

S167: The group registration unit 61 stores the group information of the received group C in the group information storage unit 601 and transmits a successful report reporting the success of the group information storage to the group managing unit 60.

S168: The group managing unit 60 transmits the successful report reporting the success of the group information creation to the screen information generating unit 51.

S169: The screen information generating unit 51 transmits a message requesting to register groups A and B as child groups of group C, to the group managing unit 60.

S170: The group managing unit 60 transmits the received request message to the group hierarchy information managing unit 68.

S171: The group hierarchical information managing unit 68 stores, in the group hierarchy information storage unit 608, information indicating that groups A and B are to be child groups of group C, based on the received request message, and transmits a registration successful report to the group managing unit 60.

S172: The group managing unit 60 transmits the registration successful report to the screen information generating unit 51.

By the above-described process, the information processing system 50 registers the information indicating that groups A and B are the child groups of group C.

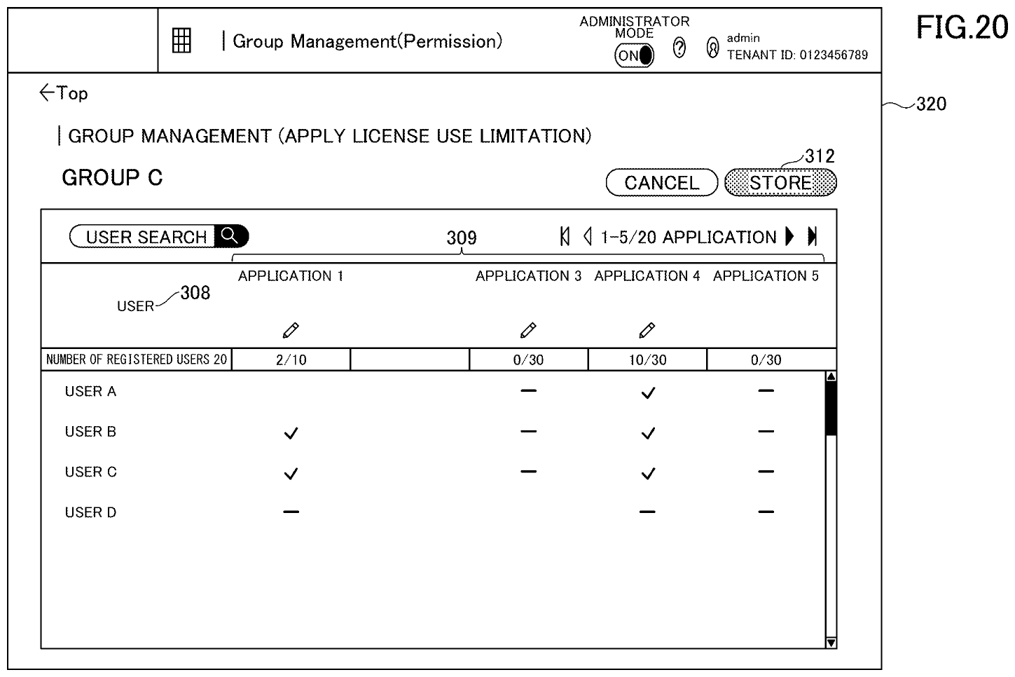

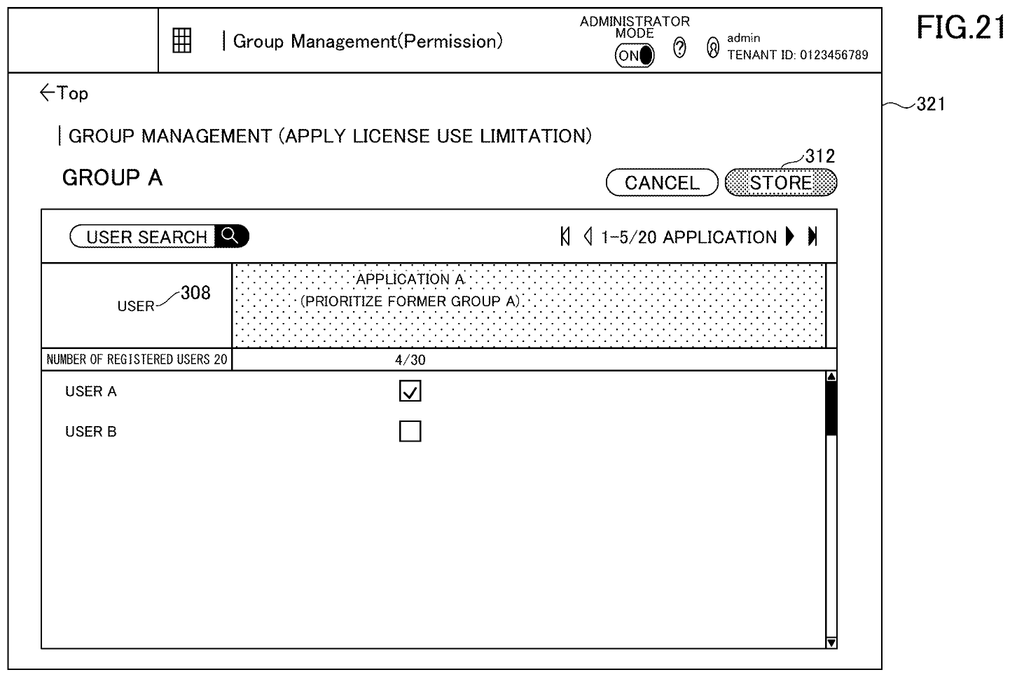

Next, an assignment process of the application use rights executed by the information processing system 50 will be described with reference to FIG. 20. FIG. 20 illustrates a group management screen 320 accessed by the tenant administrator by operating the terminal apparatus 10, to perform the application assignment of group C. The group management screen 320 displays all users 308 belonging to group C, but does not display the information of the application 309 owned by group A which is a child group of group C. That is, on the group management screen 320, only the information of the application owned by parent group C is displayed, and the application information owned by child groups A and B is not displayed. For this reason, an application owned by the parent group C can be assigned to the user 308 belonging to the child groups A and B, but the application owned by the child groups A and B cannot be assigned to the user 308. In the group management screen 320, the information of the application may not be hidden, but instead may be displayed in a grayed out manner such that the information cannot be selected. On the other hand, as illustrated in FIG. 21, in the group management screen 321 in which the tenant administrator assigns the application of group A, information of the application 309 owned by group A is displayed.

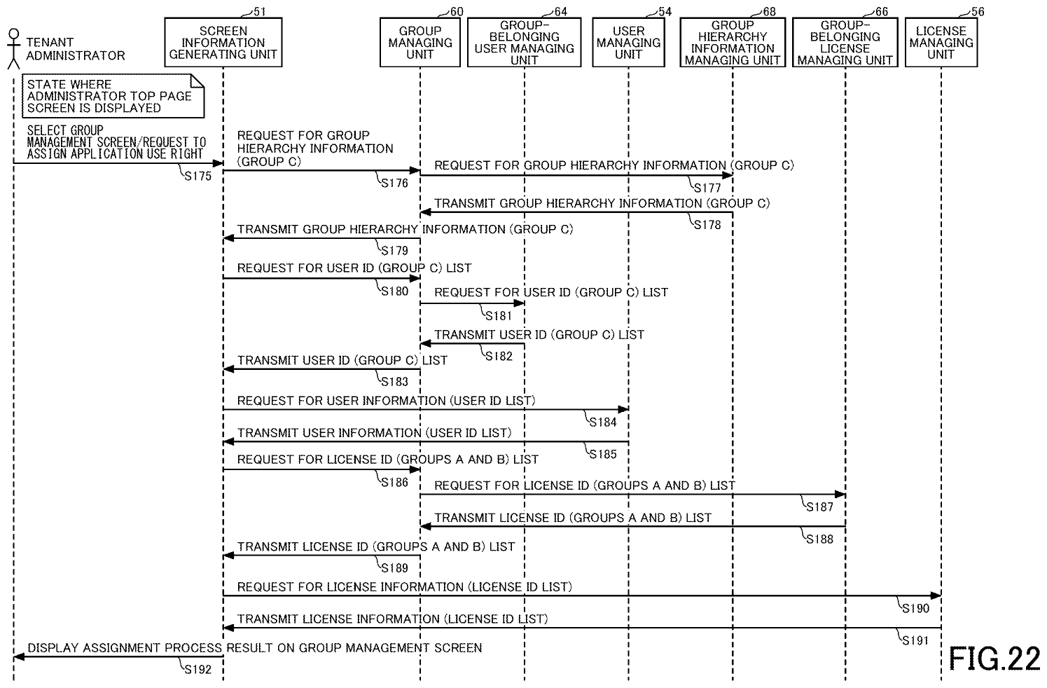

Next, in the present embodiment, the application use right assignment process performed by the information processing system 50 will be described with reference to FIG. 22. FIG. 22 is a sequence diagram illustrating an example of an application use right assignment process.

S175: The tenant administrator operates the terminal apparatus 10 to transmit a message requesting the application use right assignment from the group management screen to the screen information generating unit 51.

S176: The screen information generating unit 51 transmits a message requesting the group managing unit 60 to provide the child group information registered in group C.

S177: The group managing unit 60 transmits the received request message to the group hierarchical information managing unit 68.

S178: The group hierarchical information managing unit 68 acquires the requested group hierarchical information from the group hierarchy information storage unit 608 and transmits the requested group hierarchical information to the group managing unit 60.

S179: The group managing unit 60 transmits the received group hierarchy information to the screen information generating unit 51. Here, the group hierarchy information indicates the child groups (group A and group B) of group C.

S180: The screen information generating unit 51 transmits a message requesting the group managing unit 60 to provide a list of user IDs of users belonging to group C (including the child groups).

S181: The group managing unit 60 transmits the received request message to the group-belonging user managing unit 64.

S182: The group-belonging user managing unit 64 acquires the requested list of user IDs from the group-belonging user information storage unit 604 and transmits the list to the group managing unit 60.

S183: The group managing unit 60 transmits the received list of user IDs to the screen information generating unit 51.

S184: The screen information generating unit 51 transmits a message requesting the user managing unit 54 to provide user information (application use right assignment) of each user in the received user ID list.

S185: The user managing unit 54 acquires the requested user information from the user information storage unit 594 and transmits the requested user information to the screen information generating unit 51.

S186: The screen information generating unit 51 transmits a message requesting the group managing unit 60 to provide a list of license IDs of the licenses belonging to group C.

S187: The group managing unit 60 transmits the received request message to the group-belonging license managing unit 66.

S188: The group-belonging license managing unit 66 acquires the requested license ID list from the group-belonging license information storage unit 606 and transmits the list to the group managing unit 60.

S189: The group managing unit 60 transmits the received license ID list to the screen information generating unit 51.

S190: The screen information generating unit 51 transmits a message requesting the license managing unit 56 to provide license information (the number of licenses) of each license in the received license ID list.

S191: The license managing unit 56 acquires the requested license information from the user information storage unit 594 and transmits the requested license information to the screen information generating unit 51.

S192: The screen information generating unit 51 executes the assignment process based on the received license information, generates a group management screen in which the process result is applied, and transmits the group management screen to the terminal apparatus 10. The assignment process may be executed by the determining unit 63 in the group managing unit 60.

As described above, according to the second embodiment of the present invention, the information indicating that groups A and B are merged as the child groups of the parent group C, can be stored, and the information can be managed such that the service use rights are not shared between the child groups and the parent group.

### Third Embodiment

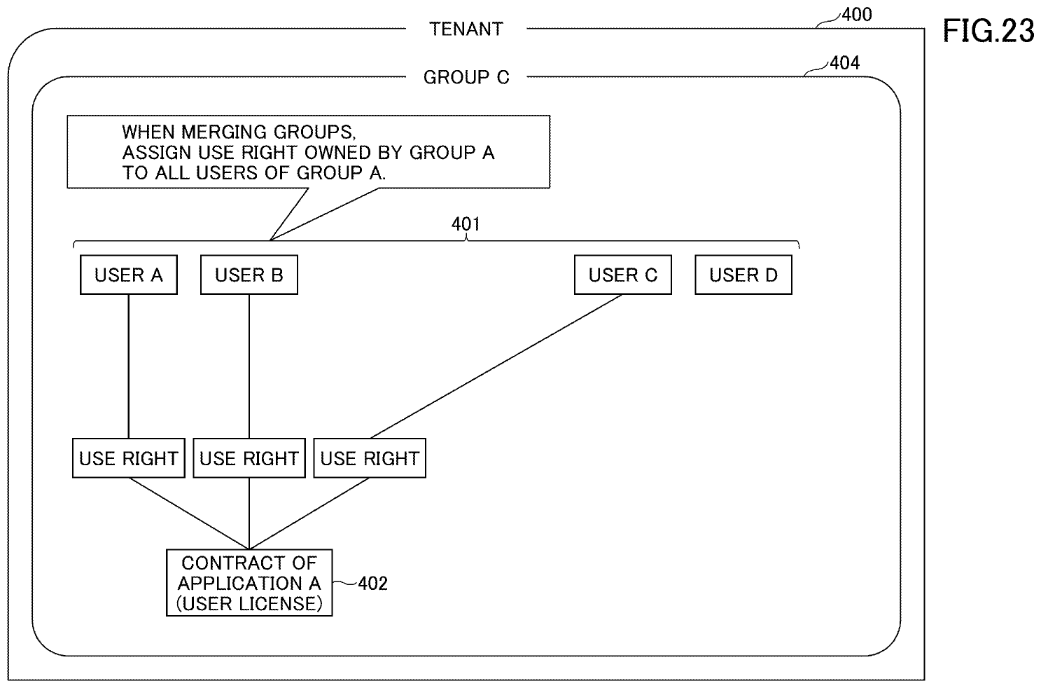

In the third embodiment, when group A and group B are merged into group C, as illustrated in FIG. 23, the use rights of application A owned by group A are first preferentially assigned to the user of group A, and all remaining use rights are assigned to users of other groups. If use rights cannot be assigned to all users, for example, the use rights are assigned in an ascending order or a descending order of the user creation time, the user names, etc.

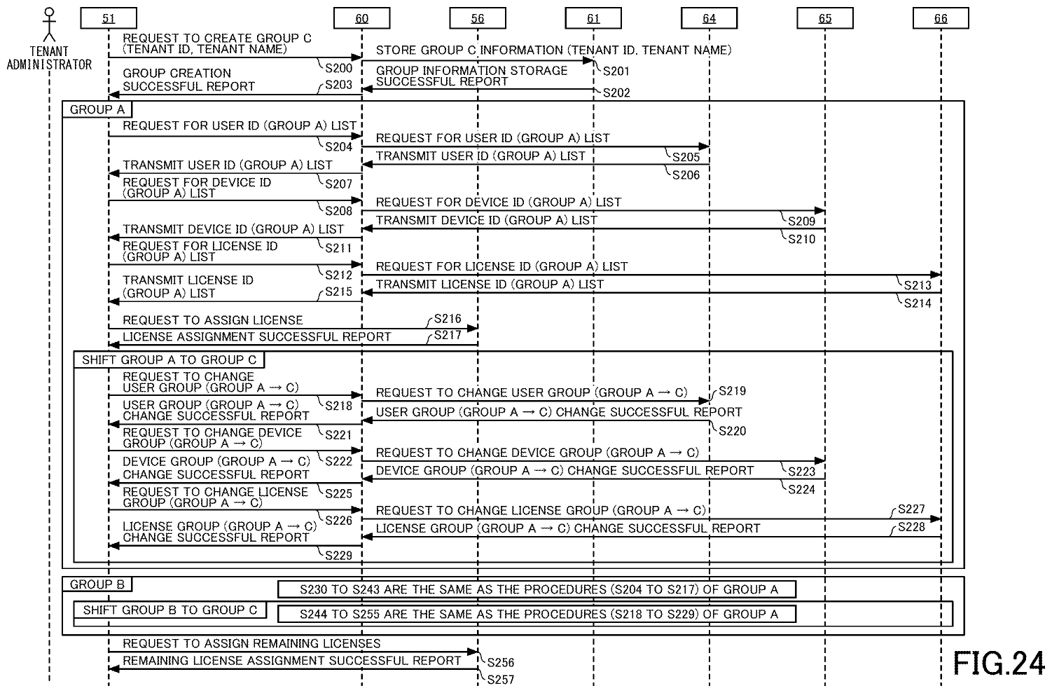

A group merging process performed by the information processing system 50 according to the present embodiment will be described with reference to FIG. 24. FIG. 24 is a sequence diagram illustrating an example of a group merging process.

S200: The screen information generating unit 51 transmits a message requesting group merger to the group managing unit 60. The request message includes the tenant ID of the tenant administrator, the group IDs of the groups to be merged (group A and group B), and the group name after merger (group C) input by the tenant administrator.

S201: The group managing unit 60 creates group C by using the information included in the received request message and transmits the group information of the created group C to the group registration unit 61.

S202: The group registration unit 61 stores the group information of the received group C in the group information storage unit 601 and transmits a successful report reporting the success of the group information storage to the group managing unit 60.

S203: The group managing unit 60 transmits the successful report reporting the success of the group information creation to the screen information generating unit 51.

S204: The screen information generating unit 51 transmits a message requesting the group managing unit 60 to provide a list of user IDs of the users belonging to group A.

S205: The group managing unit 60 transmits the received request message to the group-belonging user managing unit 64.

S206: The group-belonging user managing unit 64 acquires the requested list of user IDs from the group-belonging user information storage unit 604 and transmits the list to the group managing unit 60.

S207: The group managing unit 60 transmits the received list of user IDs to the screen information generating unit 51.

S208: The screen information generating unit 51 transmits a message requesting the group managing unit 60 to provide a device ID list of the devices belonging to group A.

S209: The group managing unit 60 transmits the received request message to the group-belonging device managing unit 65.

S210: The group-belonging device managing unit 65 acquires the requested device ID list from the group-belonging device information storage unit 605 and transmits the list to the group managing unit 60.

S211: The group managing unit 60 transmits the received device ID list to the screen information generating unit 51.

S212: The screen information generating unit 51 transmits a message requesting the group managing unit 60 to provide a list of license IDs of the licenses belonging to group A.

S213: The group managing unit 60 transmits the received request message to the group-belonging license managing unit 66.

S214: The group-belonging license managing unit 66 acquires the requested license ID list from the group-belonging license information storage unit 606 and transmits the list to the group managing unit 60.

S215: The group managing unit 60 transmits the received license ID list to the screen information generating unit 51.

S216: The screen information generating unit 51 transmits, to the license managing unit 56, a request message to assign all of the licenses in the received license ID list to the users of group A.

S217: The license managing unit 56 assigns a license based on the request message and transmits a successful report to the screen information generating unit 51.

S218: The screen information generating unit 51 transmits, to the group managing unit 60, a request message to change the group to which the users belonging to group A belongs, to group C.

S219: The group managing unit 60 transmits the received request message to the group-belonging user managing unit 64.

S220: The group-belonging user managing unit 64 updates the information stored in the group-belonging user information storage unit 604, so as to change the group to which the user belonging to group A belongs, to group C, and transmits a change successful report to the group managing unit 60.

S221: The group managing unit 60 transmits the received change successful report to the screen information generating unit 51.

S222: The screen information generating unit 51 transmits, the group managing unit 60, a request message to change the group to which the devices belonging to group A belongs, to group C.

S223: The group managing unit 60 transmits the received request message to the group-belonging device managing unit 65.

S224: The group-belonging device managing unit 65 updates the information stored in the group-belonging device information storage unit 605, so as to change the group to which the device belonging to group A belongs, to group C, and transmits a change successful report to the group managing unit 60.

S225: The group managing unit 60 transmits the received change successful report to the screen information generating unit 51.

S226: The screen information generating unit 51 transmits, to the group managing unit 60, a request message to change the group to which the license (use right of application A) belonging to group A belongs, to group C.

S227: The group managing unit 60 transmits the received request message to the group-belonging license managing unit 66.

S228: The group-belonging license managing unit 66 updates the information stored in the group-belonging license information storage unit 606, so as to change the group to which the license (the use right to use application A) belonging to group A belongs, to group C, and transmits a change successful report to the group managing unit 60.

S229: The group managing unit 60 transmits the received change successful report to the screen information generating unit 51.

The procedures of S230 to S255 for group B are performed in the same manner as the procedures of S200 to S229 for group A, and the descriptions thereof will be omitted.

S256: The screen information generating unit 51 transmits, to the license managing unit 56, a request message to assign all of the use rights of the application A owned by group C, to the users of group C.

S257: The license managing unit 56 executes the processing of assigning the use rights of application A based on the requested message, and transmits a successful report to the screen information generating unit 51. If use rights cannot be assigned to all users, for example, the use rights are assigned in an ascending order or a descending order of the user creation time, the user names, etc. The assignment process may be executed by the determining unit 63 in the group managing unit 60.

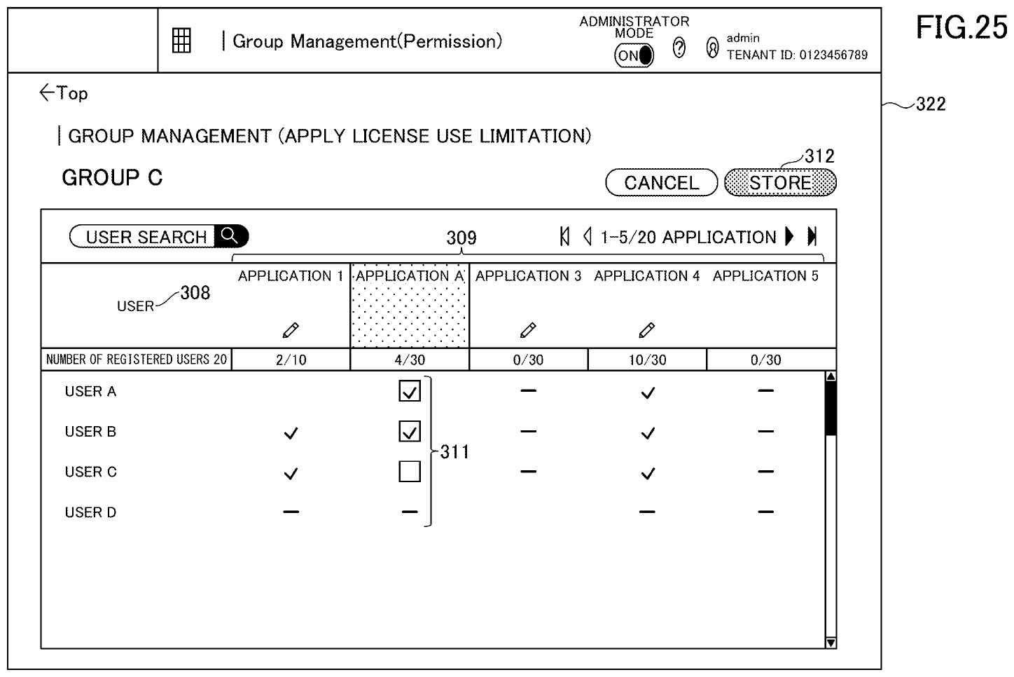

Next, a process of assigning the application use rights executed by the information processing system 50 will be described with reference to FIG. 25. FIG. 25 illustrates a group management screen 322 accessed by the tenant administrator by operating the terminal apparatus 10, to perform the application assignment to group C. The group management screen 322 is in a state of performing a use right assignment setting 311 of application A for each user 308, and the user A and the user B are granted the use right. With respect to the application A, a use right is automatically assigned to users who belonged to former group A. Further, when there is a surplus in the use rights after assigning use rights to all users who belonged to former group A, the users who belonged to former group B can be assigned the use rights. In this case, the tenant administrator may assign the use rights from the group management screen 322, or the use rights may be automatically assigned. When use rights cannot be assigned to all users in group B, for example, the use rights are assigned in an ascending order or a descending order of the user creation time, the user name, etc.

As described above, according to the third embodiment of the present invention, information on the use rights to use a service assigned prior to the group merger can be stored and managed so that the service can be used even after the group merger.

Although some embodiments of the present invention have been described, the service providing system, the information processing method, and the recording medium are not limited to the specific embodiments described in the detailed description, and variations and substitutions may be made without departing from the scope of the present invention.

Furthermore, the configuration example of FIGS. 2, 3, 5, and 6, indicated in the above embodiment is divided according to the main functions to facilitate the understanding of processes by the service providing system 1, the terminal apparatus 10, and the electronic device 40. The present invention is not limited by how the process units are divided or the names of the process units. The processes of the service providing system 1, the terminal apparatus 10, and the electronic device 40 may be further divided into many process units according to the process contents. Furthermore, the process units may be divided such that a single process unit further includes many processes.

The functions of each of the embodiments described above may be implemented by one or more processing circuits. As used herein, a “processing circuit” includes a processor programmed to execute each function by software such as a processor implemented in an electronic circuit; or devices such as an Application Specific Integrated Circuit (ASIC) a digital signal processor (DSP), a field programmable gate array (FPGA), and a conventional circuit module, designed to execute each function as described above.

Also, the apparatus group described in the examples are merely indicative of one of a plurality of computing environments for carrying out the embodiments disclosed herein. In some embodiments, the service providing system includes a plurality of computing devices, such as server clusters. The plurality of computing devices are configured to communicate with each other via any type of communication link, including networks, a shared memory, and the like, and perform the processes disclosed herein.

The electronic device 40 may be any relevant apparatus as long as a communication function is included. The electronic device 40 may be, for example, a Projector (PJ), an Interactive White Board (IWB, a whiteboard having a blackboard function capable of mutual communication), an output device such as a digital signage, a Head Up Display (HUD) device, an industrial machine, an imaging device, a sound collector, a medical device, a network appliance, a connected car, a notebook personal computer (PC), a mobile phone, a smartphone, a tablet terminal, a game machine, a Personal Digital Assistant (PDA), a digital camera, a wearable PC, a desktop PC, and the like.

According to one embodiment of the present invention, a user or a device that had been able to use a service before the group merger, can still use the service after the merger.

What is claimed is:

1. A service providing system configured to manage assignment of a use right to use a service, to a user or a device belonging to a group in a tenant, the service providing system comprising:
circuitry; and
a memory storing computer-executable instructions that cause the circuitry to execute:
generating screen information of a screen configured to accept, from the user, an assignment operation of assigning the use right of the service;
transmitting the screen information to a terminal apparatus;
assigning the use right to the user or the device belonging to the group within a limit of a number of licenses; and
managing the assignment of the use right when a first group and a second group included in the tenant are merged, such that the use right that has been available for assignment in the first group before the merger and that is not yet assigned, is preferentially assigned to the user or the device belonging to the first group.

2. The service providing system according to claim 1, further comprising:
an information processing system, wherein
the terminal apparatus is configured to communicate with the information processing system, and
the terminal apparatus is configured to display the screen based on the screen information.

3. The service providing system according to claim 1, wherein the managing includes managing the assignment of the use right such that the use right that has been available for assignment in the first group before the merger and that is not yet assigned after the merger, is preferentially assigned to the user or the device that has belonged to the first group before the merger.

4. The service providing system according to claim 1, wherein the managing includes managing the assignment of the use right when the first group and the second group before the merger are merged as child groups of a group after the merger, such that the use right that has been available for assignment in the first group before the merger and that is not yet assigned, is available for assignment to only the user or the device belonging to the first group.

5. The service providing system according to claim 1, wherein the managing includes disabling the preferential assigning of the use right.

6. An information processing method performed by a service providing system, the service providing system including (i) an information processing system configured to manage assignment of a use right to use a service, to a user or a device belonging to a group in a tenant, and (ii) a terminal apparatus configured to communicate with the information processing system, the information processing method comprising:
generating, by the information processing system, screen information of a screen configured to accept, from the user, an assignment operation of assigning the use right of the service;
transmitting, by the information processing system, the screen information to the terminal apparatus;
assigning, by the information processing system, the use right to the user or the device belonging to the group within a limit of a number of licenses;
displaying, by the terminal apparatus, the screen based on the screen information; and
managing, by the information processing system, the assignment of the use right when a first group and a second group included in the tenant are merged, such that the use right that has been available for assignment in the first group before the merger and that is not yet assigned, is preferentially assigned to the user or the device belonging to the first group.

7. A non-transitory computer-readable recording medium storing a program that causes a computer to execute a process performed in an information processing apparatus, the process comprising:
generating screen information of a screen to be displayed on a terminal apparatus to accept, from a user, an assignment operation of assigning a use right to use a service;
transmitting the screen information to the terminal apparatus;
assigning the use right to the user or a device belonging to a group within a limit of a number of licenses; and
managing the use right when a first group and a second group are merged, such that the use right that has been available for assignment in the first group before the merger and that is not yet assigned, is preferentially assigned to the user or the device belonging to the first group.
